(19) United States
(12) Patent Application Publication
(10) Pub. No.: US 2012/0097313 A1
(43) Pub. Date: Apr. 26, 2012

(54) TAPE APPLYING APPARATUS

(76) Inventors: Kozo Odawara, Osaka (JP); Keiji Fujiwara, Yamanashi (JP)

(21) Appl. No.: 13/381,752

(22) PCT Filed: Jul. 2, 2010
(86) PCT No.: PCT/JP2010/004356

§ 371 Date: Dec. 30, 2011

(30) Foreign Application Priority Data
Jul. 3, 2009 (JP) 2009-158706
Jul. 3, 2009 (JP) 2009-158707

(51) Int. Cl. H01B 1/00

(52) U.S. Cl. 156/47; 156/433

(57) ABSTRACT

A base is removably mounted to a holder mounted on a frame. A feed reel for feeding a tape member formed by lamination of a separator and anisotropic conductive tape, and a wind-up reel which is placed coaxial with the feed reel and which serves for winding up the tape member of which the anisotropic conductive tape has been press-applied to the board by a press-applying head mounted on the holder are mounted on the base.

### TECHNICAL FIELD

The present invention relates to a tape applying device for applying anisotropic conductive tape onto a printed board of liquid crystal panels, PDPs (Plasma Display Panels), organic EL (Electro-Luminescence) panels, and the like.

### BACKGROUND ART

For example, module manufacturing process for liquid crystal panels includes interconnect of board electrodes with such components as driver ICs, TCP (Tape Carrier Package) or COF (Chip on Film) or FPC (Flexible Printed Circuit) and the like, where anisotropic conductive film as an adhesive containing electrically conductive particles is used for the interconnect. A tape applying device for applying the anisotropic conductive film (hereinafter, referred to as ACF) onto an applying electrode includes: a board holding-and-moving table for holding and moving a board in horizontal-plane directions; a feed reel for feeding a tape member formed by laminating conductive tape with protective tape or so-called separator; an applying unit having a press-applying head for pressing the tape member, which is fed from the feed reel, against the board to apply the conductive tape to the board; and a wind-up reel for winding up the tape member on which the conductive tape has already been applied by the applying unit (i.e., the tape member is a separator alone). The tape applying device also includes a lower receiver (backup stage) for supporting a lower surface of the board just under a presser of the press-applying head during pressing of the tape member against the board by the press-applying head.

Among such tape applying devices is a known one in which a plurality of transfer mechanisms are placed, each of the transfer mechanisms being made up as one unit from a feed reel, a transfer head equivalent to the above-described press-applying head for pressing the tape member against the board to apply conductive tape onto the board, and a wind-up reel, so that applying operations for conductive tape onto the boards can be carried out simultaneously with a view to improving the productivity (e.g., Patent Literature 1). In addition, the productivity can be improved also by making the replacement number of both feed and wind-up reels as small as possible. For this purpose, it is effective to increase the tape length of the tape member (increase the tape length about threefold). Another known tape applying device is one in which a camera for picking up images of board-positioning board marks provided on the lower surface of the board is mounted at the lower receiver, so that the structure is simplified.

### PATENT LITERATURE

Patent Literature 1: JP 3821623 B

### DISCLOSURE OF INVENTION

### Problems to be Solved by the Invention

However, increasing the tape length of the tape member causes both feed and wind-up reels to increase in diameter, so that the whole device scale is increased, incurring a cost increase, while reel replacement itself becomes less easy to do, involving longer work-interrupt time, which may cause corresponding productivity decline, problematically. These and other problems can also occur to those devices including only one press-applying head, but are noticeable in those including a plurality of press-applying heads as described above, where in some cases, the merit that a plurality of conductive tapes can be applied simultaneously cannot be utilized enough.

Accordingly, an object of the present invention is to provide a tape applying device which allows the tape length to be increased without increasing the size of the whole device so that the working efficiency can be improved.

Also, another object of the invention is also described below.

Conventionally, the lower receiver is so designed as to be moved along with the applying unit. Therefore, for image pickup of a board mark provided on the lower surface of the board with the camera, not only the lower receiver but also the applying unit of weight are moved. As a result, the camera cannot be moved promptly, requiring longer time for board positioning, so that the working efficiency may decline as a problem.

Accordingly, another object of the invention is to provide a tape applying device, as well as a tape applying method, which allows the time required for board positioning to be shortened so that the working efficiency can be improved.

### Means to Solving the Issue

In order to solve the above problems, the present invention has the following constitutions.

According to a first aspect of the present invention, there is provided a tape applying device comprising:

a board holding table which holds a board;

an applying unit which applies an anisotropic conductive tape laminated on a tape member to a tape applying position of a side edge portion of the board; and

an applying-unit moving device which moves the applying unit relative to the board held by the board holding table, wherein

the applying unit comprises:
a feed reel from which a tape member formed by laminating a separator on the conductive tape is fed;
a press-applying head which applies the tape member fed from the feed reel to a tape applying position of the side edge portion of the board held by the board holding table by pressing the anisotropic conductive tape to the tape applying position; and
a wind-up reel which winds up the tape member after the anisotropic conductive tape has been applied to the board by the press-applying head, wherein

in the applying unit, the feed reel and the wind-up reel are placed coaxial with each other.

According to a second aspect of the present invention, there is provided the tape applying device according to the first aspect, including a plurality of the applying units, wherein

each of the applying units comprises:
a holder to which the press-applying head is mounted and which is mounted to the applying-unit moving device so as to be movable relative to the board held by the board holding table; and
a base on which the feed reel and the wind-up reel are mounted coaxial with each other and which is removably mounted to the holder.

According to a third aspect of the present invention, there is provided the tape applying device according to the first aspect, wherein the applying unit further comprises:
a wind-up reel driving device having: a first shaft which is placed coaxial with the feed reel and the wind-up reel and which is coupled to the wind-up reel; and a wind-up reel driving motor which rotationally drives the first shaft; and
a feed reel driving device having: a hollow-shaped second shaft which is placed coaxial with the first shaft on an outer peripheral side of the first shaft and which is coupled to the feed reel; and a feed reel driving motor which rotationally drives the second shaft.

According to a fourth aspect of the present invention, there is provided the tape applying device according to the second aspect, wherein each of the applying units comprises:
a wind-up reel driving device having: a first shaft which is placed coaxial with the feed reel and the wind-up reel and which is coupled to the wind-up reel; and a wind-up reel driving motor which rotationally drives the first shaft; and
a feed reel driving device having: a hollow-shaped second shaft which is placed coaxial with the first shaft n an outer peripheral side of the first shaft and which is coupled to the feed reel; and a feed reel driving motor which rotationally drives the second shaft.

According to a fifth aspect of the present invention, there is provided the tape applying device according to the fourth aspect, wherein the feed reel driving motor and the wind-up reel driving motor are mounted to the holder, and

out of the feed reel and the wind-up reel mounted coaxially in the base, the feed reel is placed closer to the holder than the wind-up reel.

According to a sixth aspect of the present invention, there is provided the tape applying device according to any one of the first through fifth aspects, further comprising a roller member which makes contact with the tape member, the anisotropic conductive tape of the tape member having been applied to the board by the press-applying head so that the tape member having become the separator alone, to eliminate residues of an adhesive remaining on the separator.

According to a seventh aspect of the present invention, there is provided the tape applying device according to the second aspect, further comprising:

a plurality of lower receivers which support lower surfaces of tape applying positions of the side edge portion of the board held by the board holding table, the lower receivers being movable within a horizontal plane relative to the board holding table;

a plurality of cameras which perform image pickup of board marks for board-positioning use in the board from below the board held by the board holding table, the cameras being provided at the respective lower receivers;

a position recognition means for performing position recognition of the board based on images of the board marks obtained by image picking up by the individual cameras, respectively; and

positioning means for operating the board holding table based on a position recognition result of the board by the position recognition means to fulfill positioning of the board to a working position, wherein

the applying-unit moving device is enabled to move the individual applying units in horizontal-plane directions independently of the individual lower receivers, respectively, and the individual applying units positioned to the individual working positions, respectively, press and apply the anisotropic conductive tape, from above the tape applying positions, to boards which are positioned at their respective working positions and whose lower surfaces of the tape applying positions are supported by their corresponding lower receivers.

According to an eighth aspect of the present invention, there is provided the tape applying device according to the seventh aspect, further comprising applying-state inspection means for inspecting an applying state of the anisotropic conductive tape to the board, the applying-state inspection means being provided in each of the applying units.

### Effect of the Invention

In the present invention, the feed reel and the wind-up reel are fitted coaxial with each other so as to be placed compact. Therefore, even if the reels are increased in diameter, the whole device is kept from being upsized. As a result, the tape length of the tape member can be increased so that the number of replacement times is lessened, by which the working efficiency can be improved.

Also, with a structure in which the feed reel and the wind-up reel are provided as a unit on the base, which is mountable to and removable from the holder, replacement of the two reels can be achieved with simplicity and moreover the time required for the replacement of the reels can be shortened, so that the working efficiency can be further improved.

### BRIEF DESCRIPTION OF DRAWINGS

These aspects and features of the present invention will become clear from the following description taken in conjunction with the preferred embodiments thereof with reference to the accompanying drawings, in which:

FIG. 1 is a perspective view of a tape applying device according to one embodiment of the present invention;

FIG. 2 is a front view of the tape applying device according to one embodiment of the invention;

FIG. 3 is a side view of the tape applying device according to one embodiment of the invention;

FIG. 4 is a plan view of the tape applying device according to one embodiment of the invention;

FIG. 5 is a front view of an applying unit included in the tape applying device according to one embodiment of the invention;

FIG. 6 is a perspective view of the applying unit according to one embodiment of the invention;

FIG. 7 is a partial exploded perspective view of the applying unit according to one embodiment of the invention;

FIG. 8 is a partial cross-section plan view of the applying unit according to one embodiment of the invention;

FIG. 9 is a partial side view of the applying unit according to one embodiment of the invention;

FIGS. 10 (a), (b) and (c) are partial enlarged front views of the applying unit according to one embodiment of the invention;

FIG. 11 is a partial enlarged front view of the applying unit according to one embodiment of the invention;

FIG. 12 is a flowchart showing an example of operation procedure of the tape applying device according to one embodiment of the invention;

FIG. 13 is a partial cross-section plan view of the tape applying device according to one embodiment of the invention;

FIG. 14 is a front view of the tape applying device according to one embodiment of the invention; and

FIG. 15 is a front view of the tape applying device according to one embodiment of the invention.

### DESCRIPTION OF EMBODIMENTS

Before the description of the present invention proceeds, it is to be noted that like parts are designated by like reference numerals throughout the accompanying drawings.

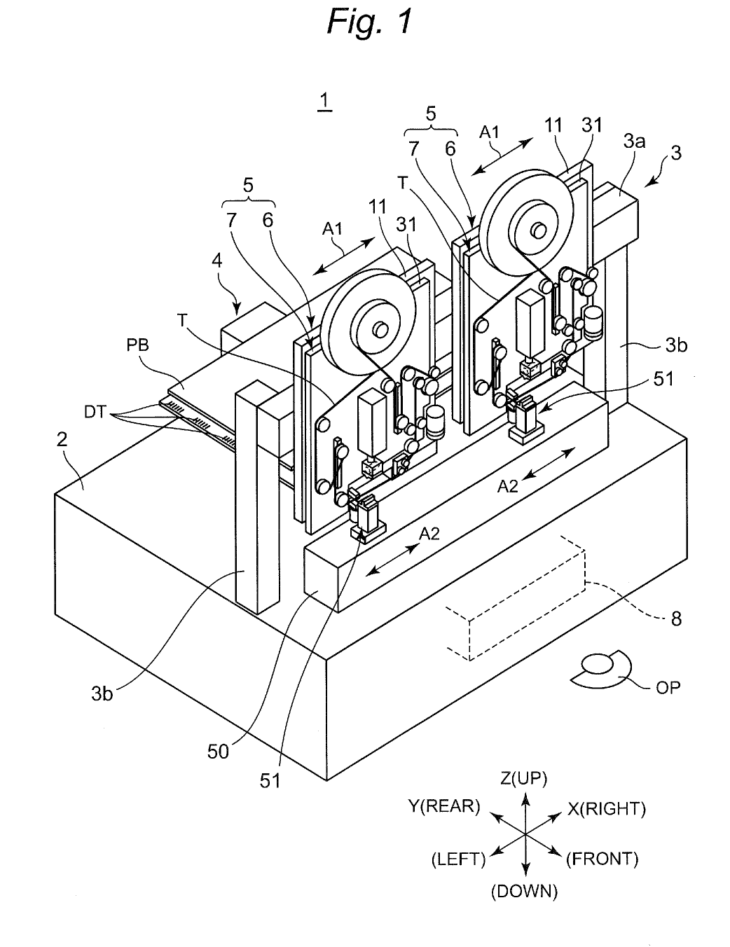

Hereinbelow, embodiments of the present invention will be described with reference to the accompanying drawings. In FIGS. 1 to 4, a tape applying device 1 has an arch-type frame 3 on a top face of a base 2, and the frame 3 has a horizontal portion 3a extending in a lateral direction of the base 2 as viewed from an operator OP and a pair of vertical portions 3b for supporting both ends of the horizontal portion 3a. In the following description, for convenience' sake, an in-horizontal-plane direction in which the horizontal portion 3a of the frame 3 extends (i.e., the lateral direction of the base 2) is assumed as an X-axis direction, while an in-horizontal-plane direction orthogonal to the X-axis direction (i.e., a back-and-forth direction of the base 2) is assumed as a Y-axis direction. Also, a vertical direction to the horizontal plane is assumed as a Z-axis direction, while a rotational direction about the Z axis is assumed as a θ direction. Further, in this tape applying device 1, an operator OP side, which is the operator's main standing side in the Y-axis direction, is assumed as a front face side (hereinafter, referred to as front side), while a side opposite to the operator OP side in the Y-axis direction is assumed as a rear side (back face side) (hereinafter, referred to as rear side or back face side).

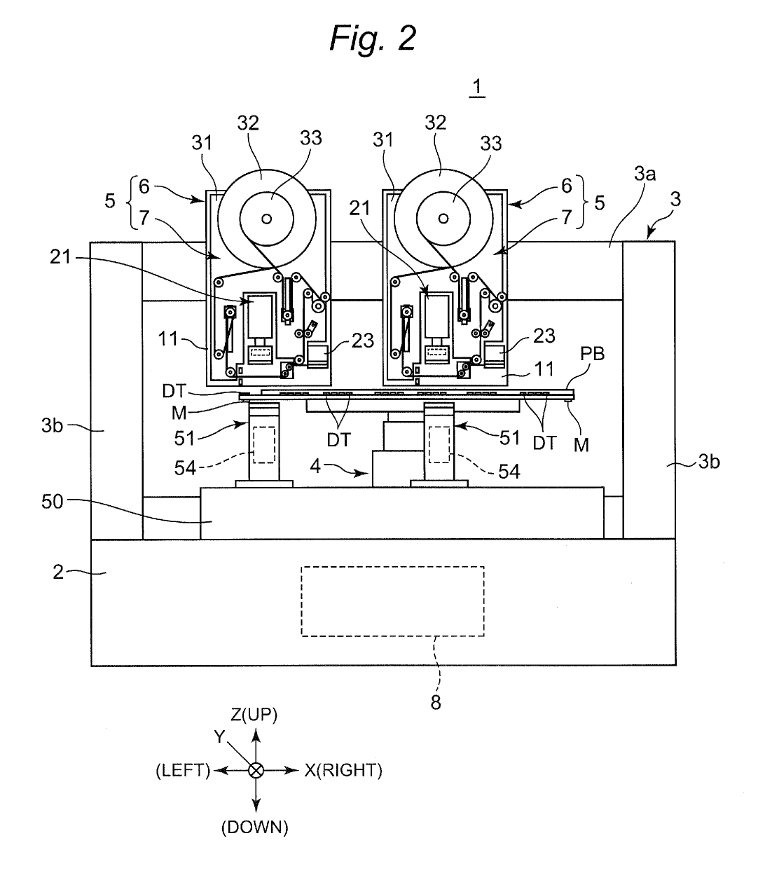

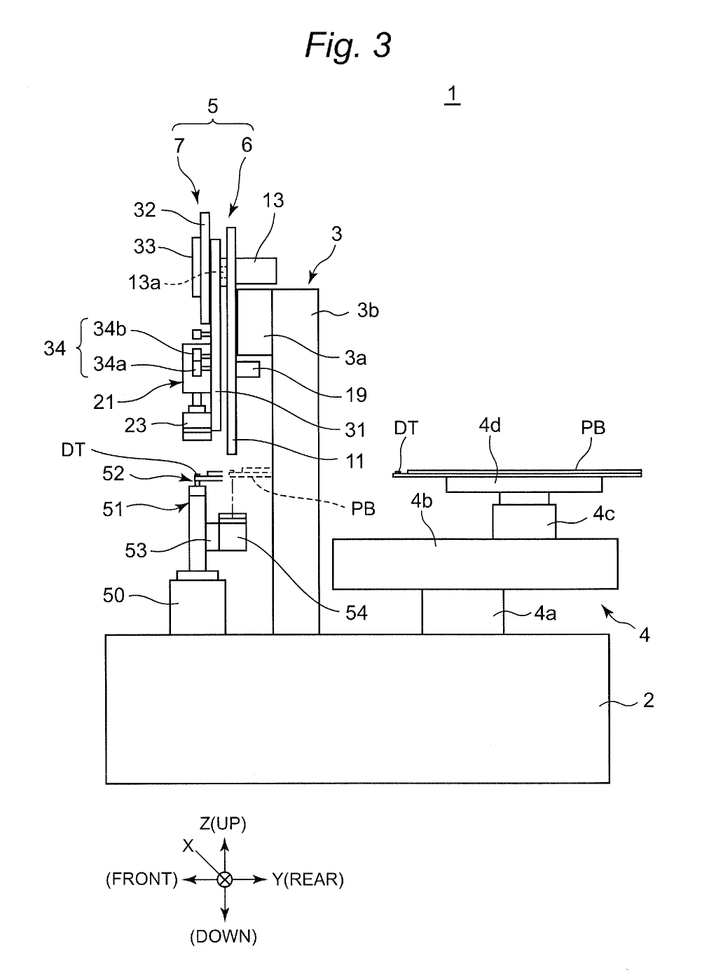

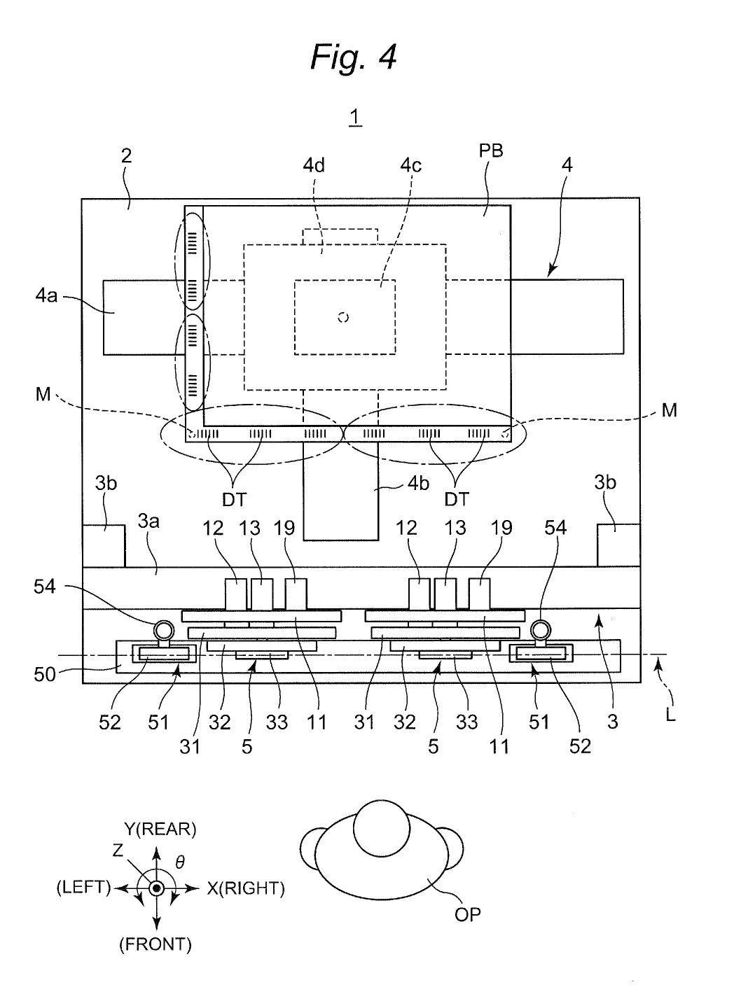

Referring to FIGS. 1 to 4, a board holding-and-moving table 4 for fulfilling holding and moving of a printed board PB (positioning to a working position) is provided in a Y-axis rear-side region of the frame 3 on the top face of the base 2. In FIGS. 3 and 4, the board holding-and-moving table 4 includes an X-table shaft 4a extending in the X-axis direction on the base 2 and working for moving in the X-axis direction a board holding part 4d with the board PB held thereon, a Y-table shaft 4b placed on the X-table shaft 4a and working for moving the board holding part 4d in the Y-axis direction, and a θ-table shaft 4c placed on the Y-table shaft 4b and working for moving the board holding part 4d up and down in the Z-axis direction and rotating the board holding part 4d in the θ direction. The board holding-and-moving table 4 serves for positioning of the board PB to a working position by moving in horizontal-plane directions (X-axis direction, Y-axis direction, Z-axis direction, and θ direction) the board PB sucked and held by an unshown board sucking mechanism placed on the top face of the board holding part 4d. Positioning control for positioning of the board PB to the working position by the board holding-and-moving table 4 is performed by a controller 8 (FIG. 2) included in the tape applying device 1.

In FIG. 4, the board PB is, for example, a board for a rectangular-shaped liquid crystal panels, and a plurality of electrodes DT to which unshown components are to be interconnected via the conductive tape ACF are provided on longer and shorter side lines, respectively, of side edge portions of the board PB. It is noted that the respective electrodes DT serve as tape applying positions where the conductive tape ACF are to be applied.

Referring to FIGS. 1 and 2, on the front side (operator OP side) of the frame 3, two applying units 5 are provided so as to be removable along the horizontal portion 3a of the frame 3 in the X-axis direction, the applying units 5 each having a press-applying head 21 for applying the conductive tape ACF of a tape member T, which is fed from a feed reel 32, to the side edge portion of the board PB. These two applying units 5 are so designed as to be movable independently of each other in the X-axis direction, which is a direction extending along the side edge portion of the board PB, relative to the board PB held by the board holding-and-moving table 4. It is noted that moving devices (not shown) for moving the two applying units 5 independently of each other in the X-axis direction are provided in the horizontal portion 3a of the frame 3. In this embodiment, this moving device, which is an example of the applying-unit moving device, can be given by using a ball screw mechanism or a linear drive mechanism as an example. Further, the applying-unit moving device needs only to have a function of moving the two applying units 5 independently of each other in the X-axis direction, “relative to” the board PB held by the board holding-and-moving table 4, without a limitation to the case in which the applying units 5 themselves are moved.

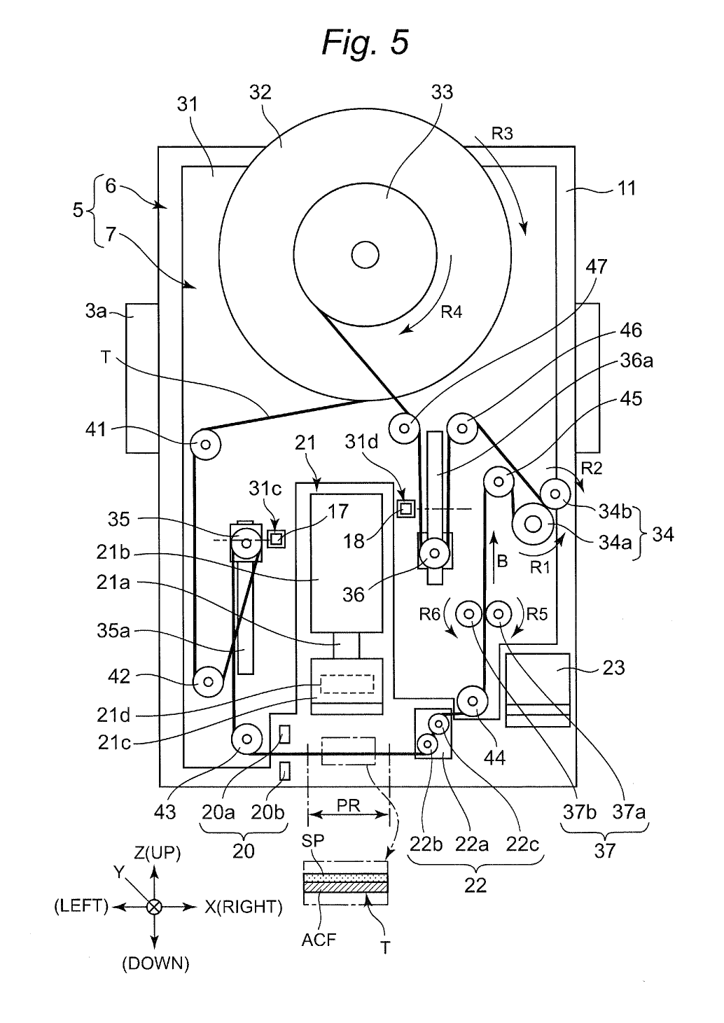

Referring to FIGS. 5, 6 and 7, each applying unit 5 includes a drive unit part 6, and a tape feeder unit part 7 removably mounted on the drive unit part 6. The drive unit part 6 includes a holder 11 on which the press-applying head 21 for applying the conductive tape ACF to the side edge portion of the board PB and which can be moved on the horizontal portion 3a of the frame 3 in the X-axis direction. The tape feeder unit part 7 includes a feed reel 32 and a wind-up reel 33 which are coaxially fitted on a base 31, where the feed reel 32 is for feeding the tape member T made up by lamination of protective tape, which is so-called separator SP, on the conductive tape ACF (partial enlarged view in FIG. 5), and the wind-up reel 33 is for winding up the tape member (separator SP alone) T which is fed from the feed reel 32 and of which the conductive tape ACF has been pressed and applied to the board PB by the press-applying head 21. The tape feeder unit part 7 has the tape member T stored therein, while the base 31 of the tape feeder unit part 7 is removably fitted to the holder 11 of the drive unit part 6.

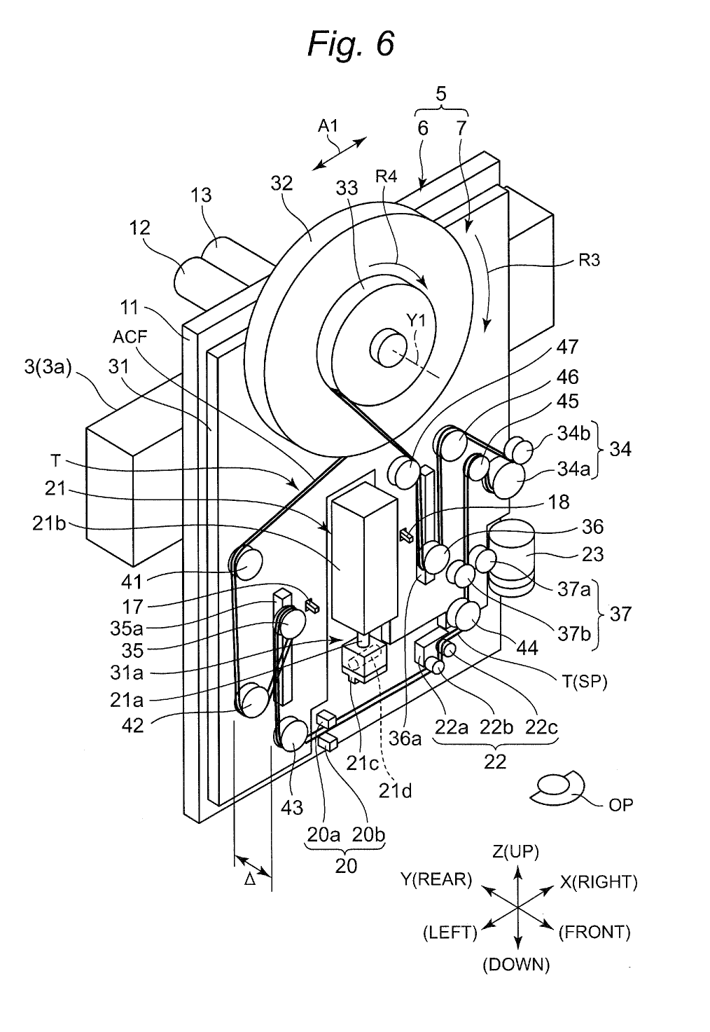

Referring to FIGS. 6, 7 and 8, the drive unit part 6 is so made up that the holder 11, which is formed of a plate member provided movable in a lateral direction, i.e. in the X-axis direction, on the horizontal portion 3a of the frame 3 (therefore movable relative to the board PB held by the board holding-and-moving table 4), is equipped with a feed reel driving motor 12, a wind-up reel driving motor 13, a driving gear 14, a driven gear 15, a hollow shaft 16, a first origin sensor 17, a second origin sensor 18, a tape-feeding-roller driving motor 19, a tape cutter 20, a press-applying head 21, a separating roller unit 22, and a tape image-pickup camera 23. In FIG. 1, with operation control of each of the holders 11 (two in this case) by an unshown ball screw mechanism provided in the horizontal portion 3a of the frame 3, the holders can be moved independently of each other on the horizontal portion 3a of the frame 3 in the X-axis direction, which is a direction extending along the side edge portion of the board PB (arrow A1 in shown in FIG. 1).

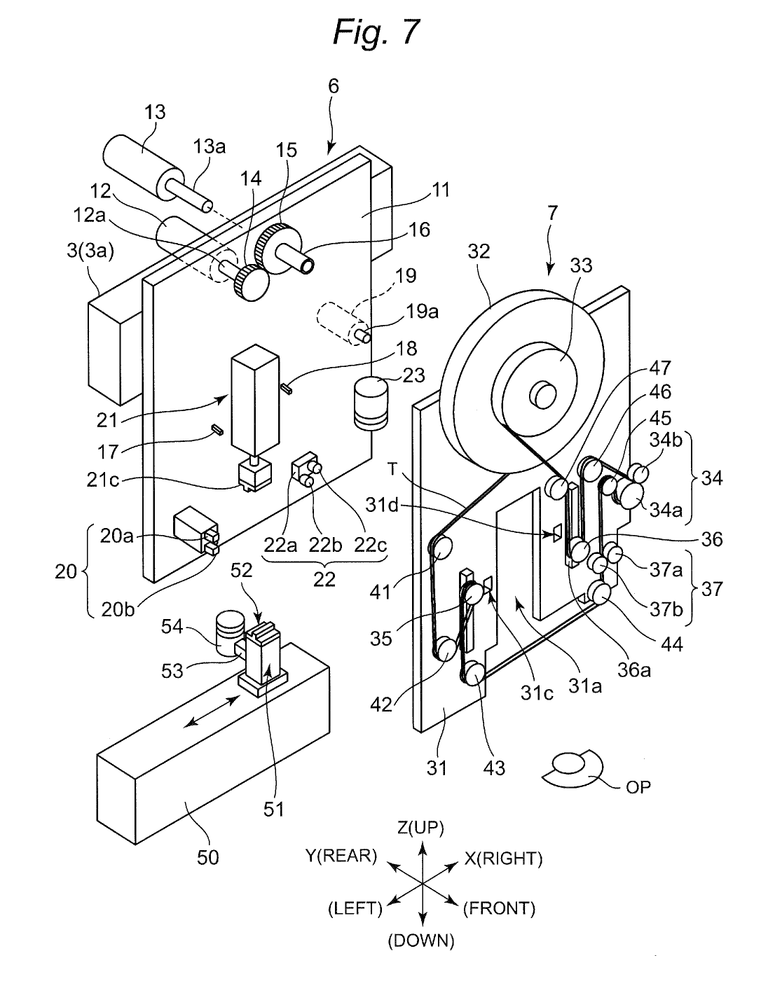

Referring to FIGS. 6 and 7, the tape feeder unit part 7 is so made up that on the front face of the base 31 formed of a plate member removably fitted to the holder 11 of the drive unit part 6 are placed not only the feed reel 32 and the wind-up reel 33 but also tape feed path means including a tape feed roller 34, a first step-gap roller 35, a second step-gap roller 36, a cleaning roller 37, and a plurality of guide rollers (first-seventh guide rollers 41, 42, . . . , 47) for winding up, and guiding to the wind-up reel 33, the tape member (separator SP alone) T which is fed from the feed reel 32 and of which the conductive tape ACF has been pressed and applied to the board PB by the press-applying head 21.

Further, a cutout portion 31a extending from lower to upper side in the Z-axis direction is provided in a center of the base 31 forming the tape feeder unit part 7, and the feed reel 32 and the wind-up reel 33 are both set coaxially about a Y1 axis extending in the Y-axis direction in an area upward of the cutout portion 31a. The wind-up reel 33, which is smaller in diameter than the feed reel 32, is provided so as to be more frontward (front face side) for the operator OP than the feed reel 32. That is, as shown in FIG. 6, the feed reel 32 and the wind-up reel 33 are mounted coaxially on the base 31 so that the feed reel 32 is placed closer to the holder 11 than the wind-up reel 33.

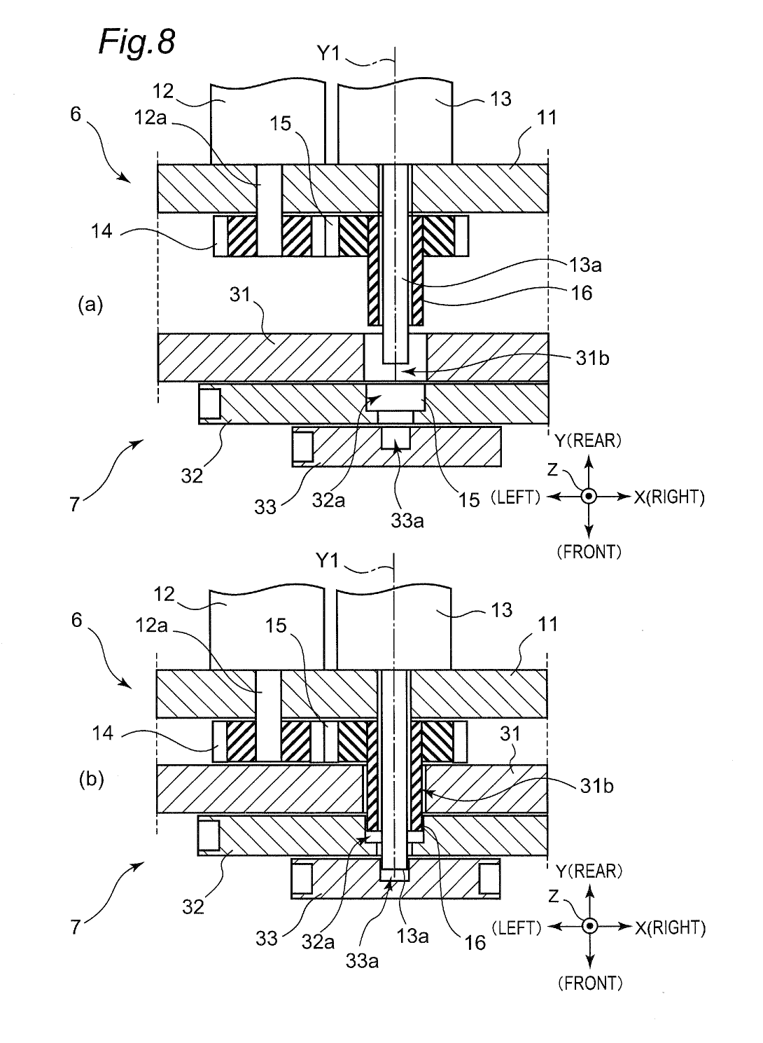

In FIG. 6 and FIG. 8(a), (b), the feed reel driving motor 12 and the wind-up reel driving motor 13 are provided in juxtaposition on the back face of the holder 11 as viewed from the operator OP side (front face side in the Y-axis direction). A drive shaft 12a of the feed reel driving motor 12 extends through the holder 11 in the Y-axis direction toward the front face side of the holder 11 so as to be coupled to the driving gear 14, which is an external gear. The hollow shaft 16 (an example of the hollow-shaped second shaft) is provided on the front face side of the holder 11 so as to be rotatable about the Y1 axis, and the driven gear 15 meshed with the driving gear 14 by the external gear is fixed to an outer peripheral surface of the hollow shaft 16. A drive shaft 13a (an example of the first shaft) of the wind-up reel driving motor 13 extends through the holder 11 in the Y-axis direction so as to project on the front side of the holder 11, and further extends through inside of the hollow shaft 16 in the Y-axis direction. That is, the hollow shaft 16 and the drive shaft 13a are placed coaxial with each other.

Referring to FIG. 8(a) and (b), when the base 31 of the tape feeder unit part 7 is fitted on the front side of the holder 11 of the drive unit part 6, the hollow shaft 16 extends in the Y-axis direction through a through hole 31b provided in the base 31 so as to be fitted into a shaft fitting hole 32a provided in the back face of the feed reel 32 so that the hollow shaft 16 and the feed reel 32 are coupled to each other. Also, by the hollow shaft 16 being fitted into a drive-shaft fitting hole 33a provided in the back face of the wind-up reel 33, the drive shaft 13a of the wind-up reel driving motor 13 and the wind-up reel 33 are coupled to each other. It is noted that the feed reel driving motor 12, the drive shaft 12a, the driving gear 14, the driven gear 15, and the hollow shaft 16 constitute a feed reel driving device, and the wind-up reel driving motor 13 and the drive shaft 13a constitute a wind-up reel driving device.

With the constitution shown above, when the drive shaft 12a of the feed reel driving motor 12 is driven with the tape feeder unit part 7 fitted to the drive unit part 6, a resulting driving force is transmitted from the driving gear 14, the driven gear 15 and the hollow shaft 16 to the feed reel 32, by which the feed reel 32 is rotated about the Y1 axis. Also, when the drive shaft 13a of the wind-up reel driving motor 13 is driven, a resulting driving force is transmitted to the wind-up reel 33, so that the wind-up reel 33 placed coaxial with the feed reel 32 is rotated about the Y1 axis. It is noted that rotational operation control for the drive shaft 12a of the feed reel driving motor 12 and rotational operation control for the drive shaft 13a of the wind-up reel driving motor 13 are performed by the controller 8. In addition, although this embodiment is described on a case in which the feed reel driving device is implemented by using a gear transmission mechanism as an example, yet a timing belt transmission mechanism as an example may also be used as a drive mechanism for the feed reel driving device or the wind-up reel driving device.

Referring to FIGS. 5 and 7, the first guide roller 41 is provided in a left-side area of the cutout portion 31a of the base 31 as viewed from the front face side, and the second guide roller 42 is provided under the first guide roller 41. The third guide roller 43 is provided right-downward of the second guide roller 42 as in the figures, and the first step-gap roller 35 is provided so as to be movable up and down along a first step-gap roller guide 35a formed of an LM guide vertically extending upward of the third guide roller 43. The first step-gap roller 35 is normally biased upward by an unshown spring member and, with no downward pulling-down load acting, is located at an origin position, which is an uppermost position for the first step-gap roller guide 35a.

Also, a through hole 31c extending through the base 31 in the Y-axis direction is provided rightward of the first step-gap roller guide 35a as in the figures, and a tip end (sensor portion) of the first origin sensor 17 provided on the front face of the holder 11 of the drive unit part 6 is protruded from the through hole 31c. The first origin sensor 17 projects inspection light horizontally toward the first step-gap roller 35 located at the origin position. When the first step-gap roller 35 is located at the origin position, the first origin sensor 17 receives the inspection light reflected by the first step-gap roller 35 so as to output a light-reception signal, and when the first step-gap roller 35 is not located at the origin position (is located below the origin position), the first origin sensor 17 does not receive the inspection light reflected by the first step-gap roller 35 so as not to output a light-reception signal. Based on such output states of a light-reception signal from the first step-gap roller 35, the controller 8 detects whether or not the first step-gap roller 35 is located at the origin position.

Referring to FIGS. 5 and 7, the separating roller unit 22 includes a movable base 22a provided in a lower right area of the holder 11 as shown in the figures so as to be movable laterally (in the X-axis direction), and a pair of rollers (first separating roller 22b and second separating roller 22c) provided on the front face of the movable base 22a. The first separating roller 22b is located on the right side of the third guide roller 43 as in the figures with the cutout portion 31a of the holder 11 interposed in the X-axis direction, and the second separating roller 22c is located in the upper right of first separating roller 22b as in the figures.

The fourth guide roller 44 is in a lower center portion of a right-side area of the cutout portion 31a of the base 31 of the tape feeder unit part 7 as viewed from the front face side, and the fifth guide roller 45 is provided upward of the fourth guide roller 44. The sixth guide roller 46 is provided upper left of the fifth guide roller 45 as in the figures, and the seventh guide roller 47 is leftward of the sixth guide roller 46 as in the figures. The second step-gap roller 36 is provided so as to be movable up and down on a second step-gap roller guide 36a formed of an LM guide extending vertically under an intermediate region between the sixth guide roller 46 and the seventh guide roller 47. The second step-gap roller 36 is normally biased downward by an unshown spring member and, with no upward pulling-up load acting, is located lower than a specified origin position (about intermediate position of the second step-gap roller guide 36a).

A through hole 31d extending through the base 31 in the Y-axis direction is provided leftward of the second step-gap roller guide 36a as in the figures, and a tip end (sensor portion) of the second origin sensor 18 provided on the front face of the holder 11 of the drive unit part 6 is protruded from the through hole 31d. The second origin sensor 18 projects inspection light horizontally toward the second step-gap roller 36 located at the origin position. When the second step-gap roller 36 is located at the origin position, the second origin sensor 18 receives the inspection light reflected by the second step-gap roller 36 so as to output a light-reception signal, and when the second step-gap roller 36 is not located at the origin position (is located below the origin position), the second origin sensor 18 does not receive the inspection light reflected by the second step-gap roller 36 so as not to output a light-reception signal. Based on such presence or absence of an output of a light-reception signal from the second step-gap roller 36, the controller 8 detects whether or not the second step-gap roller 36 is located at the origin position.

The tape feed roller 34 is made up of a driving roller and a pinch roller 34b, which are so provided that their outer peripheral surfaces are relatively pressed against each other, and the tape feed roller 34 is mounted rightward of the fifth guide roller 45 as in the figures. The tape-feeding-roller driving motor 19 is provided on the back face of the holder 11, and its drive shaft 19a extends through the holder 11 in the Y-axis direction. When the base 31 of the tape feeder unit part 7 is fitted to the front face of the holder 11 of the drive unit part 6, a portion of the drive shaft 19a of the tape-feeding-roller driving motor 19 extending toward the front face side of the holder 11 is fitted into an unshown drive-shaft fitting hole provided in the back face of a driving roller 34a, by which the drive shaft 19a of the tape-feeding-roller driving motor 19 fitted to the holder 11 and the driving roller 34a fitted to the base 31 of the tape feeder unit part 7 are coupled to each other.

Therefore, when the drive shaft 19a of the tape-feeding-roller driving motor 19 is driven with the tape feeder unit part 7 fitted to the drive unit part 6, a resulting driving force is transmitted to the driving roller 34a, by which the driving roller 34a is rotated about the Y axis while the pinch roller 34b is rotated in a direction opposite to the driving roller 34a, so that the tape member (separator SP alone) T is fed in a collectional direction by the wind-up reel 33 while the tape member (separator SP alone) T is sandwiched by the driving roller 34a and the pinch roller 34b. It is noted that rotational operation control for the drive shaft 19a of the tape-feeding-roller driving motor 19 is performed by the controller 8.

Referring to FIGS. 5 and 7, the cleaning roller 37 includes a first cleaning roller 37a and a second cleaning roller 37b, which are so provided that their outer peripheral surfaces are relatively pressed against each other. The cleaning roller 37 is placed ahead of the tape feed roller 34 in the feeding direction (arrow B direction) of the tape member (separator SP alone) T for feeding of the tape member (separator SP alone) T while the tape member (separator SP alone) is sandwiched by the driving roller 34a and the pinch roller 34b, and the cleaning roller 37 is set at a vertically intermediate portion between the fourth guide roller 44 and the fifth guide roller 45. The first cleaning roller 37a has its outer peripheral surface formed from an elastic material (e.g., urethane) having adhesiveness, and the second cleaning roller 37b has its outer peripheral surface formed from a material (e.g., Teflon (registered trademark)) weaker in adhesiveness than the side face of the first cleaning roller 37a.

The tape cutter 20 is provided in a right-side region of the third guide roller 43 in the front face of the holder 11. This tape cutter 20 is made up of an upper edge 20a and a lower edge 20b provided in vertical juxtaposition, and the conductive tape ACF of the tape member T passed through horizontally between the upper and lower edges 20a, 20b is cut (a cut line is made in the conductive tape ACF) by the upper and lower edges 20a, 20b performing opening/closing operation (cutting operation), i.e. approaching and separating relative to each other. It is noted that by this cutting operation of the tape member T with the tape cutter 20, only the conductive tape ACF laminated on the separator SP is cut off out of the tape member T, and the separator SP is not cut off.

The press-applying head 21 is provided on the holder 11 so as to be positioned within the cutout portion 31a provided in the base 31. The press-applying head 21 includes a cylinder 21b for extending in a vertical direction (Z-axis direction) and plunging a rod 21a downward, and a presser 21c provided at a lower end of the rod 21a. The presser 21c is equipped with a heater 21d.

The tape image-pickup camera 23 serving for image pickup of the conductive tape ACF applied to the board PB from upward of the board PB for inspection of an applying state of the conductive tape ACF on the board PB is provided on the holder 11 of the applying units 5, which is movable in the X-axis direction along the side edge portion of the board PB relative to the board holding-and-moving table 4 (i.e., movable relative to the board PB held by the board holding-and-moving table 4) and which is movable independently of a backup stage 51 (lower receiver) for supporting the lower surface of the side edge portion of the board PB in which the electrodes DT are provided, the tape image-pickup camera 23 being provided rightward of the fourth guide roller 44 in the front face of the base 31 of the tape feeder unit part 7 as in the figures (see FIGS. 3 and 5). The tape image-pickup camera 23, having its image-pickup field of view directed downward, picks up an image of the conductive tape ACF applied at a tape applying position on the board PB (a position where the conductive tape ACF is to be applied and where an electrode DT is provided) from upward.

Image pickup operation of the tape image-pickup camera 23 is controlled by the controller 8, and image information picked up by the tape image-pickup camera 23 is inputted to the controller 8. Then, the controller 8 makes a decision as to an applying state of the conductive tape ACF onto the board PB (presence or absence as well as goodness or non-goodness of the conductive tape ACF onto the board PB) based on the image of the conductive tape ACF obtained by the pickup by the tape image-pickup camera 23. In addition, this inspection has only to do the inspection of the applying state of the conductive tape ACF on the board PB, and therefore optical type sensors or the like may also be used instead of the image pickup camera.

In FIGS. 1 to 4, in a region which is a Y-axis direction forward region of the frame 3 placed on the top face of the base 2 and which is a lower region of the two applying units 5, a backup stage guide 50 is placed so as to extend in the lateral direction (X-axis direction) of the base 2. On the top face of the backup stage guide 50, two backup stages 51 are provided so as to be movable in the X-axis direction extending along the side edge portion of the board PB independently of each other and of the two applying units 5 (therefore independently of the two press-applying heads 21). Each backup stage 51 can be moved laterally, i.e. in the X-axis direction, along the backup stage guide 50 by operation-control of an unshown ball screw mechanism or a linear motor mechanism or the like provided in the backup stage guide 50 by the controller 8 (arrow A2 shown in FIG. 1).

Each backup stage 51 is a columnar member whose top face is formed into a flat surface 52 (see FIGS. 3 and 4), and moving tracks of the flat surfaces 52 of the individual backup stages 51 in the X-axis direction are up-and-down opposed to a moving track L (see FIG. 4) of the presser 21c of the press-applying head 21 included in the two applying units 5. Therefore, each backup stage 51 is enabled to move relatively in the X-axis direction to a position vertically opposed to the press-applying head 21 located at an arbitrary position along the horizontal portion 3a of the frame 3.

A camera supporting portion 53 protruding rearward is provided on the back face of each backup stages 51 on one side oppose to the operator OP side in the Y-axis direction, and a board mark image-pickup camera 54 having its image-pickup field of view directed upward is provided in the camera supporting portion 53. That is, the two board mark image-pickup cameras 54 included in the tape applying device 1 are enabled to move independently of each other and of the two applying units 5 in the X-axis direction. These two board mark image-pickup cameras 54 are for picking up images of board-PB-positioning use two board marks M (see FIG. 4) provided on both sides of the side edge portion of the board PB of transparent material such as glass, the image packing being done from the lower surface of the side edge portion. Image-pickup operation therefor is controlled by the controller 8, and image information about the board marks M picked up by the two board mark image-pickup cameras 54 is inputted to the controller 8. Then, the controller 8 performs position recognition of the board PB based on the images of the board marks M obtained by the image pickup by the board mark image-pickup cameras 54, and makes the board PB moved by the board holding-and-moving table 4 to achieve positioning of the board PB to the working position.

Accordingly in this embodiment, the controller 8 has, as functions of a controller, a function as a position recognition means for performing position recognition of the board PB based on images of the board marks M obtained by image pickup by the board mark image-pickup cameras 54, and a function as a board positioning means for operating the board holding-and-moving table 4 based on a position recognition result of the board PB beam position recognition means to achieve positioning of the board PB to the working position.

Referring to FIG. 5, the tape member T pulled out from the feed reel 32 is stretched over such tape feed path means as the first guide roller 41, the second guide roller 42, the first step-gap roller 35, the third guide roller 43, a first separating roller 22b and a second separating roller 22c constituting the separating roller unit 22, the fourth guide roller 44, the cleaning roller 37, the fifth guide roller 45, the tape feed roller 34, the sixth guide roller 46, the second step-gap roller 36 and the seventh guide roller 47 in this order, thus the tape member T being coupled to the wind-up reel 33. In addition, although the cleaning roller 37 is included in the tape feed path means above, yet the cleaning roller 37 does not necessarily need to be included in the tape feed path means when cleaning of the tape member T for the tape feed roller 34 located downstream in the tape feed direction (arrow B (see FIG. 5)).

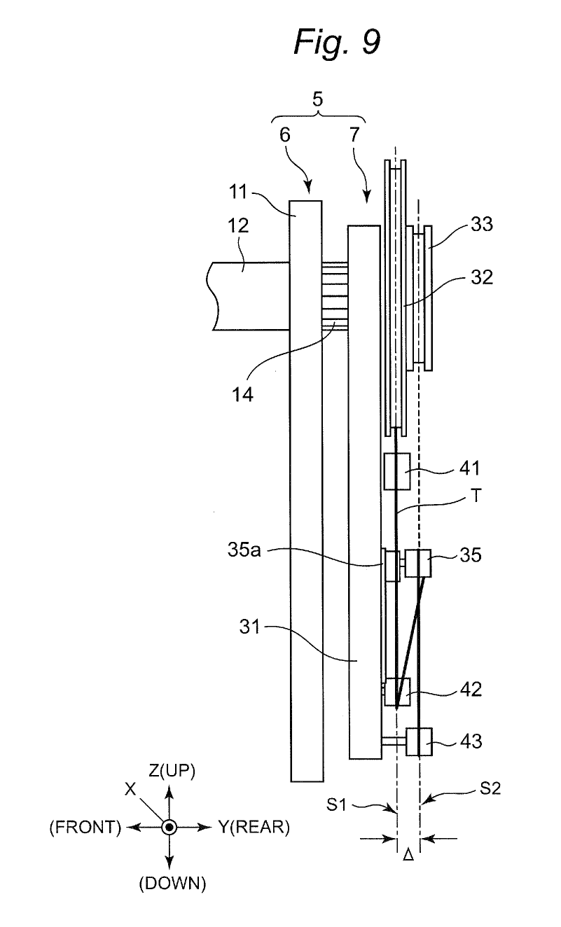

In this connection, the first guide roller 41 and the second guide roller 42 feed the tape member T within a vertical plane S1 containing a tape member T winding-up plane of the feed reel 32 as shown in FIG. 9, while the first step-gap roller 35, the third guide roller 43, the separating roller unit 22 (first separating roller 22b and second separating roller 22c), the fourth guide roller 44, the cleaning roller 37, the fifth guide roller 45, the tape feed roller 34, the sixth guide roller 46, the second step-gap roller 36 and the seventh guide roller 47 feed the tape member T within a vertical plane S2 containing the tape member T winding-up plane of the wind-up reel 33 as shown in FIGS. 5 and 6. Therefore, although the tape member T is shifted toward the front face side in the Y-axis direction by an extent corresponding to a Y-axis-direction gap (step gap) Δ between the vertical plane S1 containing the tape member T winding-up plane of the feed reel 32 and the vertical plane S2 containing the tape member T winding-up plane of the wind-up reel 33 during the progress from the second guide roller 42 to the first step-gap roller 35, yet feed and wind-up of the tape member T can be fulfilled between the feed reel 32 and the wind-up reel 33, which are placed coaxial with each other in the Y-axis direction and which are shifted to an extent corresponding to the step gap Δ.

In the above case, it is assumed that the tape member T is shifted toward the front face side in the Y-axis direction by an extent corresponding to a Y-axis-direction gap (step gap) Δ between the vertical plane S1 containing the tape member T winding-up plane of the feed reel 32 and the vertical plane S2 containing the tape member T winding-up plane of the wind-up reel 33 during the progress from the second guide roller 42 to the first step-gap roller 35. Instead, it is also allowed that the tape member T is placed coaxial in the Y-axis direction with a shift toward the front face side in the Y-axis direction by an extent corresponding to a Y-axis-direction gap (step gap) Δ between the tape member T winding-up plane of the feed reel 32 and the tape member T winding-up plane of the wind-up reel 33 during the progress from the sixth guide roller 46 to the second step-gap roller 36, and that feed and wind-up of the tape member T is performed between the feed reel 32 and the wind-up reel 33, which are shifted by the step gap Δ in the Y-axis direction.

However, in order to make up a later-described constitution that the conductive-tape ACF surface of the tape member T pulled out from the feed reel 32 is kept from contact with the surfaces of the rollers (41, 42, 35, 43) included in the tape feed path means before being applied to the board PB by the press-applying head 21, it is desirable that feed and wind-up of the tape member T is performed between the feed reel 32 and the wind-up reel 33, which are placed coaxial with each other so as to be shifted toward the front face side of the Y-axis direction by an extent corresponding to a Y-axis-direction gap (step gap) Δ between the vertical plane S1 containing the tape member T winding-up plane of the feed reel 32 and the vertical plane S2 containing the tape member T winding-up plane of the wind-up reel 33 during the progress from the second guide roller 42 to the first step-gap roller 35, and that feed and wind-up of the tape member T is performed between the feed reel 32 and the wind-up reel 33, which are shifted by the step gap Δ in the Y-axis direction.

Referring to FIGS. 2 and 5, the tape member T is fed in the horizontal direction between the third guide roller 43 and the first separating roller 22b. This is intended for the purpose that the tape member T during that progress (between the third guide roller 43 and the first separating roller 22b) becomes parallel to the surfaces of the electrodes DT which are provided in the side edge portion of the board PB held by the board holding-and-moving table 4 and to which the conductive tape ACF of the tape member T is to be applied. In addition, in the applying units 5 of this tape applying device 1, as shown in FIG. 6, the tape member T is wound on the feed reel 32 so that one side on which the conductive tape ACF is provided becomes the inner side in a shaft-center direction of the feed reel 32. Therefore, with the tape member T after being pulled out from the feed reel 32, in which the conductive tape ACF laminated on the separator SP, the separator SP on the side opposite to the side on which the conductive tape ACF is provided is put into contact with outer peripheral surfaces of the first guide roller 41, the second guide roller 42, the first step-gap roller 35 and the third guide roller 43. In the region between the third guide roller 43 and the fourth guide roller 44 in which the tape member T is fed in the horizontal direction, the conductive tape ACF is positioned at the lower surface of the tape member T.

With this constitution, since the conductive tape ACF surface of the tape member T pulled out from the feed reel 32 never makes contact with the surfaces of the rollers (41, 42, 35, 43) of the tape feed path means before being applied to the electrodes DT of the side edge portion of the board PB by the press-applying head 21, it becomes possible to prevent quality deterioration of the conductive tape ACF due to dirt or the like of the surfaces of the rollers (41, 42, 35, 43) of the tape feed path means or feed trouble of the tape member T due to adhesion of the adhesive conductive tape ACF to the surfaces of the rollers (41, 42, 35, 43) of the tape feed path means.

In FIG. 5, the tape member T passes through the cleaning roller 37 while pinched by the first cleaning roller 37a and the second cleaning roller 37b. Also, the tape member T passes through the tape feed roller 34 while pinched by the driving roller 34a and the pinch roller 34b.

In an initial state before the tape feeder unit part 7 is fitted to the drive unit part 6, the tape member T feed reel 32 and the wind-up reel 33 are fitted coaxially in the tape feeder unit part 7 that is fittable to and removable from the drive unit part 6 as described above. Also, the tape member T is stretched over the tape feed path means for guiding the tape member T to the wind-up reel 33 that winds up the tape member (separator SP alone) after the conductive tape ACF of the tape member T fed from the feed reel 32 has been pressed against and applied to the board PB by the press-applying head 21, the tape feed path means including a plurality of guide rollers (first-seventh guide rollers 41, 42, . . . , 47) as well as the tape feed roller 34, the first step-gap roller 35, the second step-gap roller 36, the separating roller unit 22 and the cleaning roller 37, and the length of the tape member T ranging from the feed reel 32 to the wind-up reel 33 is adjusted so that the first step-gap roller 35 and the second step-gap roller 36 can be positionally adjusted to their respective origin positions. Then, the tape feeder unit part 7 in this initial state is fitted to the drive unit part 6, and the controller 8 drives the drive shaft 19a of the tape-feeding-roller driving motor 19, so that the driving roller 34a of the tape feed roller 34 is rotated in a direction of arrow R1 shown in FIG. 5. As a result of this, the pinch roller 34b is rotated in a direction of arrow R2, by which the tape member T pinched by the driving roller 34a and the pinch roller 34b is advanced in the direction of arrow B shown in FIG. 5.

In addition, since the tape member T is pinched by the driving roller 34a and the pinch roller 34b, the tape member T is prevented from a large shift of the tape member T feed position even if the driving roller 34a of the tape feeder unit part 7 in the initial state (i.e., a state of not being fitted to the drive unit part 6) is separated from the drive shaft 19a of the tape-feeding-roller driving motor 19.

With progress of the tape member T in the direction of arrow B, since the feed reel 32 (and the wind-up reel 33) is initially in halt, a length of the tape member T between the feed reel 32 and the tape feed roller 34 becomes shorter, so that the first step-gap roller 35 is pulled downward from the origin position against the biasing force of a spring (not shown) fitted to the first step-gap roller guide 35a. The controller 8, upon detecting a downward move of the first step-gap roller 35 from the origin position based on an output from the first origin sensor 17 located at the origin position, drives the drive shaft 12a of the feed reel driving motor 12 so that the feed reel 32 is rotated in a direction of arrow R3 shown in FIG. 5. Thus, the tape member T is fed (wound out) from the feed reel 32.

With the tape member T fed from the feed reel 32, the length of the tape member T between the feed reel 32 and the tape feed roller 34 becomes longer, so that the first step-gap roller 35 is moved up by a biasing force of a spring (not shown) fitted to the first step-gap roller guide 35a. The controller 8, upon detecting a return of the first step-gap roller 35 to the origin position based on an output from the first origin sensor 17, halts the drive of the feed reel 32. Then, upon detecting a one more downward move of the first step-gap roller 35 from the origin position by the halt of the drive of the feed reel 32, the controller 8 resumes the drive of the feed reel 32. Thus, the length of the tape member T between the feed reel 32 and the tape feed roller 34 is maintained generally constant.

Meanwhile, with the tape member T fed toward the wind-up reel 33 side by the tape feed roller 34, the length of the tape member T between the tape feed roller 34 and the wind-up reel 33 becomes longer, the second step-gap roller 36 is moved downward from the origin position by a biasing force of a spring (not shown) fitted to the second step-gap roller guide 36a. Upon detecting a downward move of the second step-gap roller 36 from the origin position based on an output from the second origin sensor 18 located at the origin position, the controller 8 drives the wind-up reel driving motor 13 so that the wind-up reel 33 is rotated in a direction of arrow R4 shown in FIG. 5. Thus, the tape member T between the tape feed roller 34 and the wind-up reel 33 is wound up by the wind-up reel 33.

With the tape member T wound up by the wind-up reel 33, the length of the tape member T between the tape feed roller 34 and the wind-up reel 33 becomes shorter, so that the second step-gap roller 36 is pulled up, and moved up, against the biasing force of a spring (not shown) fitted to the second step-gap roller guide 36a. The controller 8, upon detecting a return of the second step-gap roller 36 to the origin position based on an output from the second origin sensor 18, halts the drive of the wind-up reel 33. Then, upon detecting a one more downward move of the second step-gap roller 36 from the origin position by the halt of the drive of the wind-up reel 33, the controller 8 resumes the drive of the wind-up reel 33. Thus, the length of the tape member T between the tape feed roller 34 and the wind-up reel 33 is maintained generally constant.

An intermediate portion of a region where the tape member T between the third guide roller 43 and the first separating roller 22b, which forms part of the separating roller unit 22, is fed horizontally serves as an applying work region PR for performing work of applying the conductive tape ACF to the tape applying position on the board PB held by the board holding-and-moving table 4 by the press-applying head 21 provided in the holder 11 of the drive unit part 6 (FIG. 5).

In this connection, the tape member T passes through between the upper edge 20a and the lower edge 20b of the tape cutter 20 before reaching the applying work region PR, where the conductive tape ACF is cut by a cutting operation of the tape cutter 20, causing a cut line to be made, so that the conductive tape ACF is cut off by a necessary length.

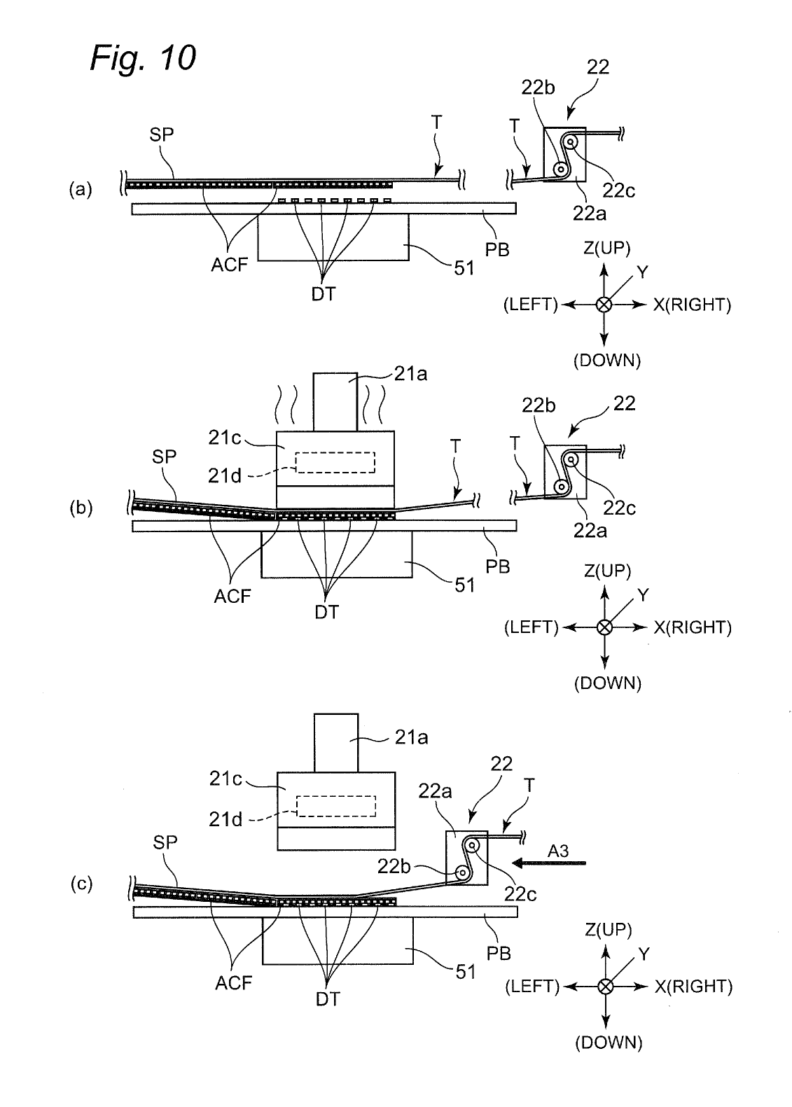

The tape member T, in which the conductive tape ACF is laminated on the separator SP with the conductive tape ACF positioned at the lower surface, is fed to the applying work region PR for the press-applying head 21 of the applying units 5. Then, while the lower surface of the side edge portion of the board PB with the electrodes DT provided therein is supported by the flat surface 52 of the backup stages 51 located just under the press-applying head 21 of the applying units 5 (i.e., just under the applying work region PR) (FIG. 10(a)), the cylinder 21b of the press-applying head 21 provided in the holder 11 of the drive unit part 6 of the applying units 5 is activated so that the rod 21a is projected downward, by which the tape member T within the applying work region PR is pressed onto the electrode DT provided in the side edge portion of the board PB supported by the backup stages 51 by the presser 21c provided at the lower end of the rod 21a and heated by the heater 21d. Then, the conductive tape ACF laminated in the tape member T is applied onto the electrode DT of the board PB (FIG. 10(b)). With the conductive tape ACF applied onto the board PB by the press-applying head 21, the cylinder 21b is activated so that the rod 21a is pulled upward, by which the presser 21c is separated from the tape member T (FIG. 10(c)).

Next, the movable base 22a of the separating roller unit 22 is moved toward the applying work region PR (FIG. 10(c), arrow A3 shown in the figure (left side in the X-axis direction as in the figure)). Thus, the tape member T (separator SP alone) is pulled upward, so that the separator SP is forcedly separated off from the conductive tape ACF applied to the board PB.

In addition, applying force of the conductive tape ACF with the separator SP is weaker than applying force of the conductive tape ACF applied to the board PB with the board PB. Therefore, whereas the separator SP is partly separated from the conductive tape ACF naturally by tensile force of the tape member T after the upward pulling-up of the presser 21c, use of the separating roller unit 22 as described above makes it possible to achieve promptly and reliably the separation of the separator SP from the conductive tape ACF applied to the board PB.

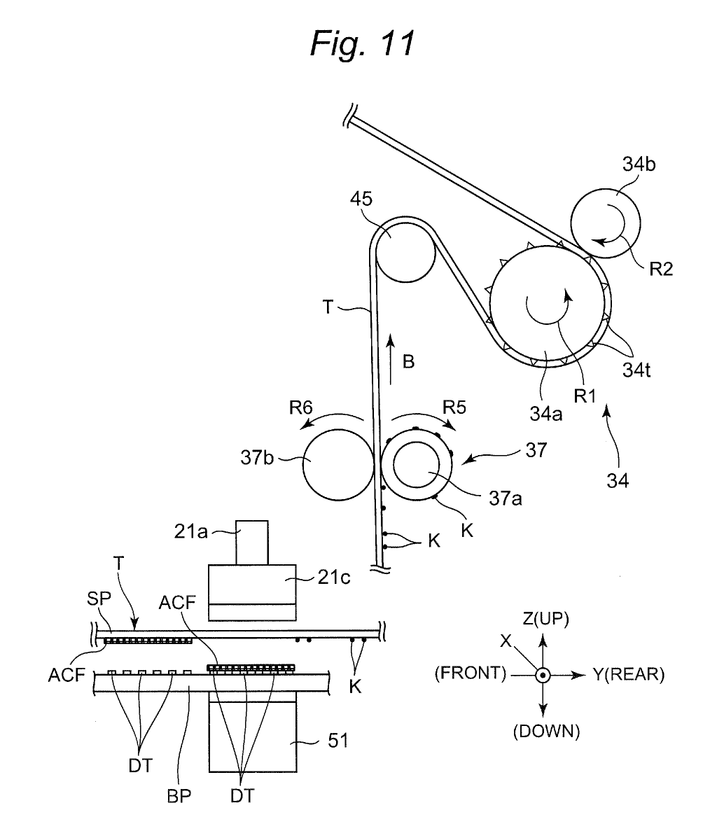

After the applying of the conductive tape ACF by the press-applying head 21, the tape member T, which is now the separator SP alone, thereafter passes through the fourth guide roller 44, the fifth guide roller 45 and then the tape feed roller 34 as shown in FIGS. 5 and 11, where residues of the adhesive have deposited (remaining) on the one-side surface on which the conductive tape ACF being the separator SP alone has been provided. Whereas the driving roller 34a of the tape feed roller 34 has a plurality of minute protrusions 34t (see FIG. 11) on its outer peripheral surface so as to achieve accurate control of the feed amount for the tape member T, deposition (transfer from the separator SP) of such residues K of the adhesive on the surface of the driving roller 34a may lead to inaccuracy of the control for the feed amount of the tape member T.

Also, when direct cleaning of the surface of the driving roller 34a with a metallic brush or the like is applied in an attempt to remove the residues K of the adhesive deposited and sticking on the surface of the driving roller 34a, the plurality of minute protrusions 34t provided on the outer peripheral surface of the driving roller 34a are worn more and more by the cleaning, resulting in inaccuracy of the control for the feed amount of the tape member T. Moreover, even if the surface of the driving roller 34a is cleaned directly before residues K of the adhesive stick to the surface of the driving roller 34a, adhesive components of the residues K remain on the surface of the driving roller 34a, causing the surface of the driving roller 34a to become gummy unstably and leading to inaccuracy of the control for the feed amount of the tape member T.

However, with the applying units 5 of this tape applying device 1, the tape member T that has become a separator SP alone before reaching the driving roller 34a passes through the cleaning roller 37 while the first cleaning roller 37a is rotated in one direction (arrow R5 shown in FIG. 11) and the second cleaning roller 37b is rotated in the opposite direction (arrow R6 shown in FIG. 11). In this operation, the surface of the tape member T on one side with the residues K of the adhesive remaining is put into contact with the first cleaning roller 37a formed from an elastic material such as urethane material or the like having adhesiveness so that the residues K of the adhesive are removed, thus eliminating the possibility of inaccuracy of the control for the feed amount of the driving roller 34a due to the residues K of the adhesive. In addition, it is preferable that the first cleaning roller 37a and the second cleaning roller 37b can be fitted to and removed from the base 31 of the tape feeder unit part 7 so as to be replaceable and cleanable so that the surface of the driving roller 34a can be maintained normally clean (with no residues of the adhesive remaining).

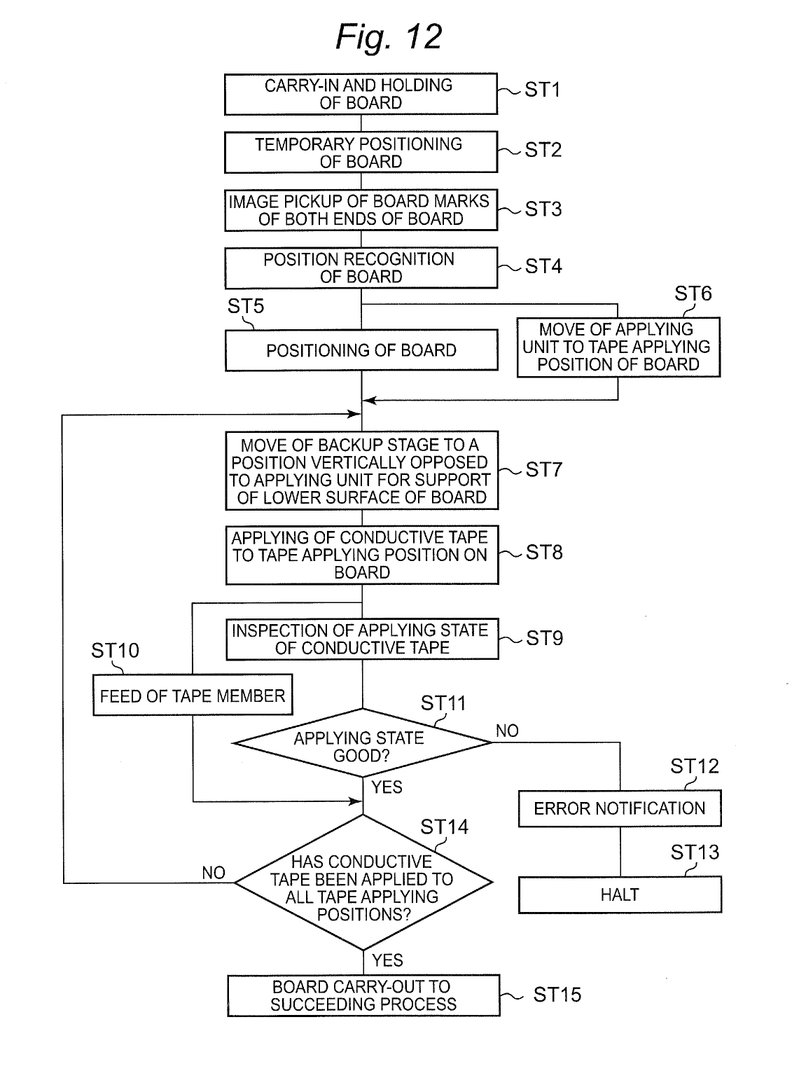

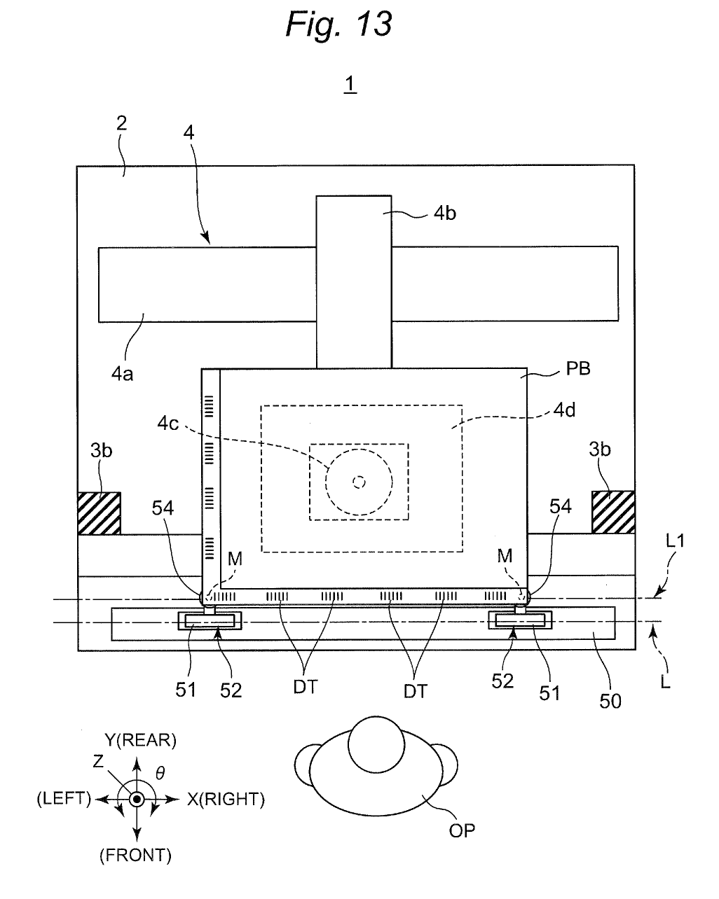

Next, the procedure for applying the conductive tape ACF to the tape applying position on the board PB by using the tape applying device 1 made up as described above will be described below with reference to the flowchart of FIG. 12 and FIGS. 13 to 15, and FIG. 3. For applying of the conductive tape ACF to the tape applying position on the board PB, first, the controller 8 operates an unshown board conveying device so that a board PB is carried into the tape applying device 1, and then the board PB is placed sucked and held on the board holding part 4d of the board holding-and-moving table 4 (step ST1 of FIG. 12). Then, the board holding-and-moving table 4 is operated so that two board marks M provided on both end sides of the side edge portion of the board PB of glass or other transparent material are positioned generally immediately above a moving track L1 of the board mark image-pickup camera 54 formed by the backup stages 51 being moved in the X-axis direction on the backup stage guide 50 (see the board PB shown in broken line in FIGS. 13 and 3), thus temporary positioning of the board PB being achieved (step ST2).

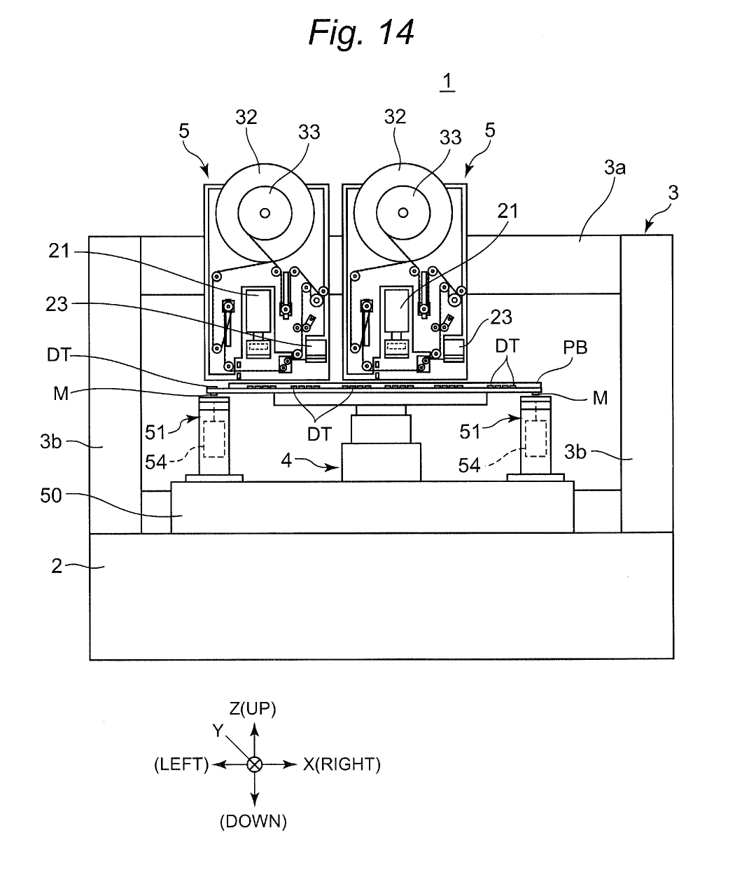

Upon completion of the temporary positioning of the board PB, the controller 8 makes the two backup stages 51 each moved in the X-axis direction, so that the board mark image-pickup cameras 54 included in the two backup stages 51, respectively, are positioned just under the board marks M on both end sides of the side edge portion of the board PB, which are image pickup positions of the board marks M in the X-axis direction (FIGS. 13 and 14), where these two board mark image-pickup cameras 54 are made to pick up images of the board marks M, respectively (step ST3).

In the above description, for image pickup of the board marks M by the respective board mark image-pickup cameras 54, the temporary positioning of the board PB is performed before the two backup stages 51 are moved to the image pickup positions of the board marks M in the X-axis direction. Instead, however, the temporary positioning of the board PB and the move of the backup stages 51 in the X-axis direction may be performed substantially simultaneously for the image pickup positions of the board marks M. Further, the two backup stages 51 may also be moved in the X-axis direction so as to be moved to the image pickup positions of the board marks M before temporary positioning of the board PB.

Over the image pickup of the two board marks M on both end sides of the board PB by the two board mark image-pickup cameras 54, the controller 8 performs image recognition based on image pickup results (images) of the two board marks M to do position recognition of the board PB for calculating a positional shift of the board PB (θ-direction positional shift of the board PB) (step ST4).

Subsequent to the position recognition of the board PB, the controller 8 operates the board holding-and-moving table 4 based on the position recognition result to do positioning (positioning and positional correction) to the working position, which is a position for work of applying the conductive tape ACF to a plurality of tape applying positions in the side edge portion of the board PB held by the board holding-and-moving table 4 (step ST5). More specifically, this positioning of the board PB to the working position is achieved by operating the board holding-and-moving table 4 so that the whole board PB is rotated in the θ direction so as to cancel a positional shift, for example, in the θ direction, based on the position recognition result determined at step ST4, and moreover by moving the whole board PB held by the board holding-and-moving table 4 forward in the Y-axis direction so that the tape applying position of the board PB held by the board holding-and-moving table 4 is positioned just under the X-axis direction moving track L of the press-applying head 21 (presser 21c) included in each of the two applying units 5.

Then, during the position recognition of the board PB (or before the position recognition of the board PB), the controller 8 moves the two applying units 5 to above the tape applying positions, respectively, of the board PB held by the board holding-and-moving table 4 as shown in FIG. 14 (step ST6).

Then, upon completion of the positioning of the board PB to the working position in step ST5, the two backup stages 51 are moved to positions vertically opposed to the two applying units 5, respectively, so that the tape applying positions of the side edge portion of the board PB positioned to the working position are vertically interposed therebetween. The board PB held by the board holding part 4d of the board holding-and-moving table 4 is moved relative to two backup stages 51 in the Z-axis direction, so that the lower surfaces of the tape applying positions of the board PB are supported by the two backup stages 51 (step ST7). As a result of this, the two applying units 5 and the two backup stages 51 are combined each as one set of vertically opposed ones with the tape applying positions of the board PB vertically interposed. In this case, the conductive tape ACF of the tape member T that is going to be applied is positioned within the applying work region PR of each applying unit 5 (see FIG. 5). It is noted that one applying unit 5 and one backup stage 51 as one set described above are movable in the X-axis direction independently of each other.

In addition, supporting operation of the lower surface of the tape applying positions of the board PB held by the board holding part 4d of the board holding-and-moving table 4 by the two backup stages 51 is achieved by moving down the board holding part 4d, by which the board PB is held, in the Z-axis direction. Otherwise, the supporting operation may also be fulfilled by providing and moving up an up/down moving means (not shown) such as a ball screw mechanism, linear motor drive mechanism or air cylinder mechanism as the two backup stages 51 so as to support the lower surfaces of the tape applying positions of the board PB.

Also, in this tape applying device 1, the two backup stages 51 and the two applying units 5 are movable independently of each other in the X-axis direction, which is a direction extending along the side edge portion of the board PB. Therefore, during the process of image pickup of the board marks M (i.e., position recognition of the board PB) by the two board mark image-pickup cameras 54 (see FIG. 14), the two applying units 5 having the tape member T feed reel 32, the wind-up reel 33 and the tape feed path means can be moved in advance, by their respective independent operations independently of the X-axis-direction move of the two backup stages 51, to the tape applying positions on the X-axis-direction moving track L of the press-applying head 21 serving for applying of the conductive tape ACF to the electrodes DT in the side edge portion of the board PB by the press-applying head 21 of the applying units 5. As a result of this, effects of residual vibrations due to positioning movement of the two applying units 5, which are larger in size than the backup stages 51, can be suppressed so that the applying operation of the conductive tape ACF by the press-applying head 21 can be performed immediately after completion of the positioning of the board PB to the X-axis direction positions of the moving track L as well as the positioning of positions where the two backup stages 51 are vertically opposed to the press-applying heads 21 with the tape applying positions on the board PB interposed therebetween (see FIG. 4).

In this case, it is desirable that the board marks M for image pickup are positioned on both sides of the board PB as much as possible, as shown in FIG. 14, in order to achieve positional correction of the board PB with higher precision. After image pickup and position recognition of the board marks M positioned on both end sides of the board PB are performed by the board mark image-pickup cameras 54 included in the backup stages 51 that are movable in the X-axis direction, the two backup stages 51 are moved independently of the two applying units 5, respectively, so that the two backup stages 51 are positioned so as to be vertically opposed to the press-applying heads 21 of the two applying units 5, respectively, with the tape applying positions on the board PB interposed therebetween. For this movement, since the feed reel 32 and the wind-up reel 33 are placed in juxtaposition coaxially in the Y-axis direction in each of the applying units 5, it is difficult to apply conductive tape ACF simultaneously to neighboring two tape applying positions of the board PB while the two applying units 5 each having a width size larger than the reel diameter of the feed reel 32 or the wind-up reel 33, whichever it is larger in diameter, are juxtaposed in the X-axis direction.

For this reason, not that the conductive tape ACF is applied to the tape applying positions of the side edge portion one after another from both end sides of the board PB toward the X-axis direction center of the side edge portion of the board PB while the two applying units 5 are moved in their mutually approaching directions, but that, for example, the X-axis direction left-side applying unit 5 as in the figures is moved so that the conductive tape ACF is applied to a tape applying position positioned at an X-axis direction left-side end of the board PB, and the X-axis direction right-side applying unit 5 as in the figures is moved so that the conductive tape ACF is applied to a tape applying position positioned on the X-axis direction right side more than the center side of the side edge portion of the board PB. Then, as is desirable, the two applying units 5 are moved toward the X-axis direction right side, one by one, so that the two applying units 5 do not interfere with each other, and the conductive tape ACF is applied to a plurality of tape applying positions simultaneously.

In the above-described applying process, with respect to the two applying units 5, the X-axis direction left-side applying unit 5 as in the figures is positioned at an X-axis direction left-side end of the board PB, and the X-axis direction right-side applying unit 5 as in the figures is positioned on the X-axis direction right side of the center side of the side edge portion of the board PB, in which arrangement the applying units 5 are moved to the X-axis direction right side, one by one, so that the conductive tape ACF is applied to a plurality of tape applying positions, simultaneously. However, the positions and directions may be reversed from the above ones. The requirement is that the two applying units 5 do not interfere with each other in the simultaneous applying of the conductive tape ACF to a plurality of tape applying positions.

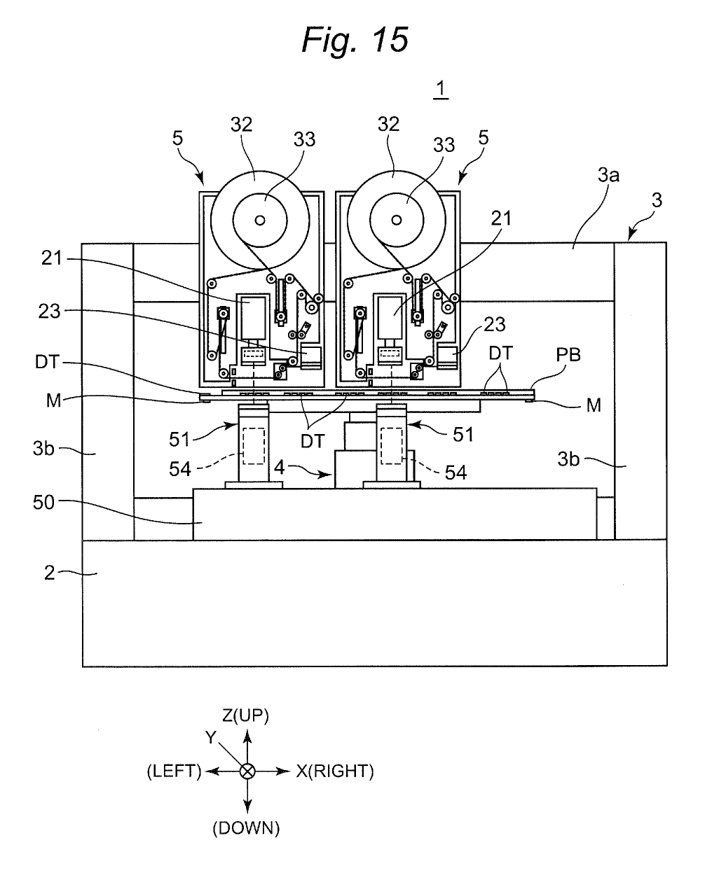

By the controller 8, the two backup stages 51 are moved to X-axis direction positions of the moving track L corresponding to the tape applying positions on the board PB, respectively, and then, as shown in FIG. 15, the board holding part 4d of the board holding-and-moving table 4, by which the board PB is held, is lowered and operated so that the lower surface of the side edge portion of the board PB, on which the electrodes DT are provided, is supported by the flat surface 52 of the backup stage 51. Along with this, by the controller 8, the press-applying head 21 of each applying unit 5 is activated so that the presser 21c of the press-applying head 21 heated by the heater 21d presses the tape member T to the tape applying position on the electrode DT of the side edge portion of the board PB, the lower surface of the side edge portion of the board PB being supported by the backup stage 51, by which the conductive tape ACF is applied to the electrode DT of the board PB (step ST8).

By the controller 8, after the conductive tape ACF of the tape member T is applied to the tape applying positions on the board PB by the press-applying head 21 of the applying unit 5, the presser 21c of the press-applying head 21 is moved up, so that the tape member (separator SP alone) T is separated from the conductive tape ACF applied to the tape applying positions, and the applying unit 5 is moved apart from the board PB. Thereafter, by the controller 8, the two applying units 5 are moved respectively and independently of the X-axis direction move of the backup stages 51 by which the lower surface of the side edge portion of the board PB with the electrodes DT provided therein is supported, so that the tape image-pickup camera 23 included in each applying unit 5 is moved to just above the conductive tape ACF applied to the side edge portion of the board PB by the press-applying head 21 of the applying unit 5. Then, image pickup of the conductive tape ACF is performed by each tape image-pickup camera 23 to perform the inspection of the applying state of the conductive tape ACF (step ST9). Also, in parallel with this step ST8, the controller 8 performs an operation for feeding the tape member T by a specified amount to the applying work region PR of the press-applying head 21 so that the tape member T is positioned at the next tape applying position in each applying unit 5 for preparation of succeeding applying of the conductive tape ACF (step ST10).

After the inspection of the applying state of the conductive tape ACF applied by each applying unit 5 at step ST9, the controller 8 then makes a decision as to the applying state of the conductive tape ACF is good or not (step ST11). As a result, when the applying state of the conductive tape ACF is decided as defective due to recognition of a peeling, break or the like of the conductive tape ACF, the operator OP is notified of an error (step ST12) and operation of the applying unit 5 is halted (step ST13). Meanwhile, when the applying state of the conductive tape ACF is decided as defective at step ST11, it is decided whether or not the conductive tape ACF has been applied to all the tape applying positions in the board PB that is currently subject to the applying work of the conductive tape ACF (step ST14).

At step ST14, when the conductive tape ACF has not yet been applied to all the tape applying positions, the program returns to step ST7, where the two applying units 5 and the two backup stages 51 are moved to positions corresponding to new tape applying positions, respectively, to do applying work of the conductive tape ACF for tape applying positions where the conductive tape ACF has not yet been applied. For example, as shown in FIG. 4, in a case where the electrodes DT being the tape applying positions are provided at six places in the longer side of the board PB and at four places in the shorter side so that the applying work of the conductive tape ACF by the two applying units 5, simultaneously with each one piece of conductive tape ACF, is repeated five times in all (three for the longer side, two for the shorter side), the loop of returning from step ST14 to step ST7 is repeated five times in all. It is noted that positioning of the board PB for switching between the applying work of conductive tape ACF for the longer side of the board PB and the applying work of conductive tape ACF for the shorter side of the board PB is fulfilled by rotating the board holding part 4d of the board holding-and-moving table 4 by 90°.

Meanwhile, if the conductive tape ACF has already been applied to all the tape applying positions of the board PB at step ST14, the controller 8 operates the above-mentioned board conveying device (not shown) so that the board PB on the board holding-and-moving table 4 is carried outside of the tape applying device 1 (step ST15).

With the tape applying device 1 of this embodiment, the above-described steps are repeated to fulfill the applying of the conductive tape ACF to a plurality of tape applying positions of a plurality of boards PB. Then, when there arises a need for replacement of the feed reel 32 and the wind-up reel 33 with the tape member T fed out from the feed reel 32, the operator OP removes the tape feeder unit part 7, which is provided as a unit removably fitted to the holder 11 in juxtaposition, from the holder 11 of the drive unit part 6, and fits a new tape feeder unit part 7, in which the feed reel 32 and the wind-up reel 33 are replaced for the tape feeder unit part 7 by off-line work, to the holder 11 of the drive unit part 6.

As described above, the tape applying device 1 of this embodiment includes: a board holding-and-moving table 4 for holding the board PB; a holder 11 which is movable relative to the board PB held by the board holding-and-moving table 4; a base 31 removably fitted to the holder 11; a feed reel 32 which is fitted to the base 31 and which serves for feeding a tape member T formed by lamination of the separator SP on the conductive tape ACF; a press-applying head 21 which is fitted to the holder 11 and which serves for pressing the tape member T fed from the feed reel 32 against the board PB held by the board holding-and-moving table 4 to fulfill the applying of the conductive tape ACF; and a wind-up reel 33 which is fitted to the base 31 so as to be coaxial with the feed reel 32 and which serves for winding up the tape member T of which the conductive tape ACF has already been applied to the board PB by the press-applying head 21.

Also, this tape applying device 1 includes an applying units 5 for applying the conductive tape ACF laminated on the tape member T to tape applying positions of the side edge portion of the board PB, where the applying units 5 includes: a feed reel 32 for feeding a tape member T formed by lamination of the separator SP on the conductive tape ACF; a press-applying head 21 for pressing the tape member T fed from the feed reel 32 to tape applying positions of the side edge portion of the board PB whose lower surface is supported by the backup stages 51, which is a lower receiver, to fulfill the applying of the conductive tape ACF to the board PB; and a wind-up reel 33 for winding up the tape member T of which the conductive tape ACF has already been applied to the board PB by the press-applying head 21, wherein the feed reel 32 and the wind-up reel 33 for the tape member T are fitted to the applying units 5 so as to be coaxial with each other.

In the tape applying device 1 of this embodiment, the feed reel 32 and the wind-up reel 33 are fitted to the applying unit 5 of the tape applying device 1 so as to be coaxial with each other in juxtaposition and placed compact. Therefore, even if the tape length of the tape member T to be wound up is increased so that the two reels 32, 33 are increased in diameter, the whole device is kept from being upsized, as compared with the case in which the feed reel 32 and the wind-up reel 33 are placed in juxtaposition substantially on a plane. As a result, the tape length of the tape member T is increased so that the replacement interval of the reels 32, 33 is elongated and the number of replacement times is lessened, by which the working efficiency can be improved. Also, for this reason, even with adoption of a layout in which the set of the feed reel 32 and the wind-up reel 33 (corresponding to the applying unit 5) is provided in some plurality in the lateral direction (X-axis direction) as in this embodiment, it is possible to suppress upsizing of the whole tape applying device 1 in the X-axis direction (especially the equipment line length is suppressed).

Furthermore, the feed reel 32 and the wind-up reel 33 are provided as a unit on the base 31, which is fittable to and removable from the holder 11 of the drive unit part 6, so as to make up the tape feeder unit part 7. Therefore, replacement of the two reels 32, 33 of the tape feeder unit part 7 removed from the holder 11 of the drive unit part 6 within the tape applying device 1 (on line) can be fulfilled in advance by off-line work or during the replacement by off-line work. Also, only by removing and fitting the tape feeder unit part 7, in which replaced feed reel 32 and wind-up reel 33 for the tape member T are fitted to the base 31, to the holder 11 of the drive unit part 6, the replacement work can be achieved with simplicity and moreover the production interrupted time for the replacement can be largely cut down, so that the working efficiency can be further improved.

Moreover, the feed reel driving motor 12 (feed reel driving means) for driving the feed reel 32 and the wind-up reel driving motor 13 (wind-up reel driving means) for driving the wind-up reel 33 are provided in the holder 11 of the drive unit part 6. Therefore, for replacement of the tape feeder unit part 7 including the two reels 32, 33 for the purpose of replacement of the two reels 32, 33, it is required only to replace parts excluding its drive means (feed reel driving motor 12 and wind-up reel driving motor 13). Thus, the tape feeder unit of the cassette structure to be replaced can be made more lightweight for the drive unit part 6.

Also, the tape applying device 1 of this embodiment includes a first cleaning roller 37a as a roller member for eliminating residues K of the adhesive remaining on the separator SP due to contact with the tape member T that has become a separator SP alone after the applying of the conductive tape ACF to the board PB by the press-applying head 21. Therefore, the feed amount for the tape member T can be controlled normally accurately. Also, the tape applying device 1 of this embodiment includes: a board holding-and-moving table 4 for holding a board PB and moving the board PB in horizontal-plane directions; a backup stages 51 as a lower receiver which is provided movable within a horizontal plane relative to the board holding-and-moving table 4 and which serves for supporting a lower surface of a tape applying position in the side edge portion of the board PB held by the board holding-and-moving table 4; a board mark image-pickup cameras 54 which is provided on the backup stages 51 and which serves for performing image pickup of a board mark M for board positioning included in the board PB from below the board PB held by the board holding-and-moving table 4; a position recognition means (controller 8) for performing position recognition of the board

PB based on an image of the board mark M obtained by the image pickup by the board mark image-pickup cameras 54; a board positioning means (controller 8) for operating the board holding-and-moving table 4 based on a position recognition result of the board PB by the position recognition means to perform positioning of the board PB to a working position; and an applying unit 5 which is provided movable in horizontal-plane directions independently of the backup stage 51 and positioned to a working position and which serves for pressing and thereby applying anisotropic conductive tape (film) ACF against the board PB from upward of a tape applying positions of the board PB of which the lower surface of the tape applying position is supported by the backup stage 51. In addition, in this embodiment, the backup stages 51 including the board mark image-pickup camera 54 is provided in a plural number (two).

A tape applying method of this embodiment is a tape applying method by a tape applying device 1 including: a board holding-and-moving table 4 for holding a board PB and moving the board PB within a horizontal plane; two backup stages 51 as lower receivers which are provided movable relative to the board holding-and-moving table 4 and which serves for supporting lower surfaces of a plurality of tape applying positions, individually, of the side edge portion of the board PB held by the board holding-and-moving table 4; two board mark image-pickup cameras 54 which are provided in the two backup stages 51, respectively, and which serve for performing image pickup of two board marks M from below the board PB while being positioned below the board-positioning use two board marks M provided in the board PB held by the board holding-and-moving table 4; and two applying units 5 which are provided movable in horizontal-plane directions independently of the two backup stages 51 and positioned to working positions being positions for work of applying the conductive tape ACF to a plurality of tape applying positions in the side edge portion of the board PB of the board PB held by the board holding-and-moving table 4 based on a position recognition result of the board PB based on images of the two board marks M obtained by image pickup of the two board mark image-pickup cameras 54 and which serve for pressing and applying the conductive tape ACF to the tape applying positions of the board PB of which lower surfaces of the tape applying positions are supported by the two backup stages 51.

This tape applying method includes: steps of moving two backup stages 51 relative to the board PB held by the board holding-and-moving table 4, respectively, picking up images of the two board marks M provided in the board PB by the two board mark image-pickup cameras 54 from below the board PB, and performing position recognition of the board PB based on images obtained (steps ST3 and step ST4); a step of operating the board holding-and-moving table 4 based on a position recognition result of the board PB to do positioning of the board PB to a working position (step ST5); moving the two applying units 5 to above tape applying positions, respectively, of the board PB held by the board holding-and-moving table 4 to which the conductive tape ACF is applied in the working position during process of the position recognition of the board PB (or before performing the position recognition of the board PB) (step ST6); a step of moving the two backup stages 51 so that the two tape applying positions of the side edge portion of the board PB positioned to the working position are vertically interposed against the two applying units 5, and that lower surfaces of the tape applying positions of the board PB are supported by the two backup stages 51 (step ST7); and a step of applying the conductive tape ACF to the two tape applying positions of the board PB of which the lower surfaces of the tape applying positions are supported by the two tape applying units 5 (step ST8). Furthermore, this embodiment includes a step, which is to be performed subsequent to step ST8, of performing an inspection of an applying state of the conductive tape ACF to the board PB by tape image-pickup cameras 23 included in the two applying units 5, respectively (step ST9).

In the tape applying device 1 of this embodiment, since the board mark image-pickup cameras 54 for picking up images of the board marks M provided in the board PB are mounted on the backup stages 51 that are provided movable independently of the applying units 5, move of the board mark image-pickup cameras 54 involved in the image pickup of the board marks M is only the move of the backup stages 51 involving no move of the applying units 5 that are larger-sized as compared with the backup stages 51 serving as lower receivers. The applying units 5 not only have larger size as compared with the backup stages 51, but also should not be moved at relatively high speeds in terms of their holding the tape member T. From these points of view, the backup stages 51 and the board mark image-pickup cameras 54 can be moved at high speeds, as compared with the applying units 5. Therefore, before the process of position recognition of the board PB or during the process of the position recognition of the board PB, the board mark image-pickup cameras 54 for image pickup of the board marks M can be moved promptly subsequent to the position recognition of the board PB, by moving the two applying units 5 to above the tape applying positions, respectively, of the board PB held by the board holding-and-moving table 4 where the conductive tape ACF is to be applied in the working position. Thus, the time required for positioning of the board PB can be shortened, so that the working efficiency can be improved. In particular, in the tape applying device 1 of this embodiment, since a plurality of backup stages 51 each including the board mark image-pickup camera 54 is provided in a plural number (two), images of the two board marks M provided at both ends of the board PB can be picked up simultaneously, so that the positioning of the board PB can be achieved in extremely short time.

Although an embodiment of the present invention has been described hereinabove, yet the invention is not limited to the one shown by the above-described embodiment. For example, although the applying units 5 are provided two in number in the above embodiment, yet the number of the applying units 5 may be one, or three or more. Further, the way how the tape member T is stretched in the applying units 5 is shown as an example only and not limited to the one described above.

For example, in a case of device structure where the tape applying device 1 includes only one applying unit 5, it is conceivable that the tape applying device 1 of such a structure is placed in a plural number in adjacency, so that the applying work of conductive tape for a plurality of boards is carried out simultaneously. Even with such a device structure, it is also desired that the tape length should be increased for improvement of working efficiency without upsizing the individual devices.

It is to be noted that, by properly combining the arbitrary embodiments of the aforementioned various embodiments, the effects possessed by them can be produced.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

The present invention provides a tape applying device which allows the tape length to be increased without increasing the size of the whole device so that the working efficiency can be improved.

Also, the invention provides a tape applying device, as well as a tape applying method, which allows the time required for board positioning to be shortened so that the working efficiency can be improved.

The entire disclosure of Japanese Patent Application No. 2009-158706 A filed on Jul. 3, 2009, including specification, claims, and drawings, as well as the entire disclosure of Japanese Patent Application No. 2009-158707 A filed on Jul. 3, 2009, including specification, claims, and drawings are incorporated herein by reference in its entirety.

1. A tape applying device comprising:
a board holding table which holds a board;
an applying unit which applies an anisotropic conductive tape laminated on a tape member to a tape applying position of a side edge portion of the board; and
an applying-unit moving device which moves the applying unit relative to the board held by the board holding table, wherein
the applying unit comprises:
a feed reel from which a tape member formed by laminating a separator on the conductive tape is fed;
a press-applying head which applies the tape member fed from the feed reel to a tape applying position of the side edge portion of the board held by the board holding table by pressing the anisotropic conductive tape to the tape applying position; and
a wind-up reel which winds up the tape member after the anisotropic conductive tape has been applied to the board by the press-applying head, wherein
in the applying unit, the feed reel and the wind-up reel are placed coaxial with each other.

2. The tape applying device according to claim 1, including a plurality of the applying units, wherein
each of the applying units comprises:
a holder to which the press-applying head is mounted and which is mounted to the applying-unit moving device so as to be movable relative to the board held by the board holding table; and
a base on which the feed reel and the wind-up reel are mounted coaxial with each other and which is removably mounted to the holder.

3. The tape applying device according to claim 1, wherein the applying unit further comprises:
a wind-up reel driving device having: a first shaft which is placed coaxial with the feed reel and the wind-up reel and which is coupled to the wind-up reel; and a wind-up reel driving motor which rotationally drives the first shaft; and
a feed reel driving device having: a hollow-shaped second shaft which is placed coaxial with the first shaft on an outer peripheral side of the first shaft and which is coupled to the feed reel; and a feed reel driving motor which rotationally drives the second shaft.

4. The tape applying device according to claim 2, wherein each of the applying units comprises:
a wind-up reel driving device having: a first shaft which is placed coaxial with the feed reel and the wind-up reel and which is coupled to the wind-up reel; and a wind-up reel driving motor which rotationally drives the first shaft; and
a feed reel driving device having: a hollow-shaped second shaft which is placed coaxial with the first shaft n an outer peripheral side of the first shaft and which is coupled to the feed reel; and a feed reel driving motor which rotationally drives the second shaft.

5. The tape applying device according to claim 4, wherein the feed reel driving motor and the wind-up reel driving motor are mounted to the holder, and
out of the feed reel and the wind-up reel mounted coaxially in the base, the feed reel is placed closer to the holder than the wind-up reel.

6. The tape applying device according to claim 1, further comprising a roller member which makes contact with the tape member, the anisotropic conductive tape of the tape member having been applied to the board by the press-applying head so that the tape member having become the separator alone, to eliminate residues of an adhesive remaining on the separator.

7-8. (canceled)

9. A tape applying method for applying an anisotropic conductive tape laminated on a tape member to a tape applying position of a side edge portion of the board after positioning the tape applying position to the anisotropic conductive tape by moving an applying unit for applying the anisotropic conductive tape relative to the board, the method comprising:
feeding the tape member in which an separator is laminated on the anisotropic conductive tape from a feed reel mounted on the applying unit;
pressing and then applying the anisotropic conductive tape of the tape member to the tape applying position of the side edge portion of the board with use of a press-applying head mounted to the applying unit; and
winding up the tape member after the anisotropic conductive tape has been applied to the board by a wind-up reel, the feed reel and the wind-up reel being mounted coaxial with each other to the applying unit.
